(19) United States
(12) Patent Application Publication
(10) Pub. No.: US 2014/0127665 A1
(43) Pub. Date: May 8, 2014

(54) LEARNING APPARATUS

(71) Applicant: Toshifumi Arai, Saitama (JP)

(72) Inventor: Toshifumi Arai, Saitama (JP)

(73) Assignee: CITIZEN HOLDINGS CO., LTD., Tokyo (JP)

(21) Appl. No.: 14/128,596

(22) PCT Filed: Jun. 25, 2012
(86) PCT No.: PCT/JP2012/066178

§ 371 Date: Dec. 21, 2013

(30) Foreign Application Priority Data
Jun. 23, 2011 (JP) 2011-139332
Aug. 29, 2011 (JP) 2011-186028

(51) Int. Cl. G09B 7/06

(52) U.S. Cl. CPC G09B 7/06
USPC 434/362

(57) ABSTRACT

The purpose of the present invention is to provide a learning device capable of increasing a learning effect by utilizing the operation of the subconscious mind during sleep. Provided is a learning device comprising: a time counting means; a time setting means which sets a question posing time of a question to be presented to a user; a question posing means which poses the question on the basis of the setting made by the time setting means; and a presenting means which, prior to the question posing time of the question, presents to the user in advance a content relating to the question posed by the question posing means.

### TECHNICAL FIELD

The present invention relates to a learning apparatus constructed by integrating an alarm function used in an alarm clock or the like with a learning function for helping to improve a user's learning ability.

### BACKGROUND

It is known in the art to provide an apparatus that combines an awakening device such as an alarm clock with an electronic learning assisting device thereby aiming to awaken a user at a set time without fail while assisting the user to continue learning every day even if the user is a weak-willed person (for example, refer to patent document 1).

Patent document 1 discloses a combination apparatus constructed by combining an awakening device with an electronic learning assisting device in which, as shown in FIG. 25, when an answer is entered into an answer entering means D to a question presented by a question presenting means C, an answer judging means B judges whether the answer is right or wrong. The combination apparatus includes an awakening stimulus control means A which controls an awakening stimulus output means E based on the result of the judgment made by the answer judging means B. Further, the combination apparatus is constructed so that the awakening stimulus from the awakening stimulus output means E, i.e., the alarm, does not stop as long as the percentage of correct answers or the number of consecutive correct answers does satisfy a preset condition.

It is also known that sleep helps learning (helps memory to become stable). That is, what is remembered before sleep tends to become stable in memory.

### PRIOR ART DOCUMENTS

### Patent Documents

Patent document 1: Japanese Unexamined Patent Publication No. H08-166761 (Claim 1 and FIG. 1)
Patent document 2: “Interfering with Theories of Sleep and Memory,” Current Biology 16, 1290-1294, Jul. 11, 2006

### SUMMARY

However, the combination apparatus disclosed in patent document 1 has only been intended to make the user solve new questions every time he wakes up, and has not been strategically designed to enhance the learning effect. There has also been the problem that the time to get up is delayed because no account is taken of the time the user expends to solve the questions when he wakes up. Furthermore, since the question presentation pattern is determined without considering the time interval that elapses from the time of the alarm activation to the time that the user gets up, the disadvantage has been that the apparatus is unable to provide the user with sufficient motivation to get up early.

An object of the present invention is to provide a learning apparatus that can solve the above problems.

Another object of the present invention is to provide a learning apparatus that can enhance the learning effect by utilizing unconscious activity during sleep.

A further object of the present invention is to provide a learning apparatus that can enhance the learning effect without delaying the time to get up and can thus enhance the user's motivation to get up early.

The combination apparatus disclosed in patent document 1 has been unable to achieve a sufficient learning effect because the learning materials and learning methods provided to the user lack variety.

Accordingly, an object of the present invention is to provide a learning apparatus that can enhance the learning effect by providing a variety of learning materials and learning methods to the user, and a learning system that uses such a learning apparatus.

A learning apparatus includes timer, time setting unit for setting a presentation time of a question to a user, question presenting unit for presenting the question in accordance with the setting made by the time setting unit, and preview presenting unit for presenting to the user, before the presentation time of the question, a preview of contents related to the question to be presented by the question presenting unit.

Preferably, in the learning apparatus, the contents the preview of which is presented by the preview presenting unit include the question to be presented by the question presenting unit.

Preferably, in the learning apparatus, the contents the preview of which is presented by the preview presenting unit further includes a hint about an answer to the question to be presented by the question presenting unit.

Preferably, in the learning apparatus, the contents the preview of which is presented by the preview presenting unit further includes a method of solving the question to be presented by the question presenting unit.

Preferably, the learning apparatus further comprises operating unit for accepting an answer from the user.

Preferably, in the learning apparatus, the time setting unit is an alarm setting unit for setting an alarm, and the learning apparatus further includes alarm activating unit for activating the alarm in accordance with the setting made by the time setting unit, and alarm stopping unit for stopping the alarm, wherein the alarm setting unit adjusts the time at which the alarm activating unit activates the alarm, according to the quantity or quality of the questions to be presented by the question presenting unit.

Preferably, in the learning apparatus, the alarm stopping unit has a snooze function, and increases or decreases the number of questions to be presented by the question presenting unit, according to the number of alarm activations that occurred due to activation of the snooze function.

Preferably, the learning apparatus further includes presentation content adjusting unit for adjusting presentation content according to a time difference between an alarm setting time, at which the alarm activation time is set by the alarm setting unit, and the alarm activation time.

Preferably, in the learning apparatus, the presentation content adjusting unit adjust the presentation content by reducing the quantity or quality of the questions when the time difference is small and by increasing the quantity or quality of the questions when the time difference is large.

Preferably, in the learning apparatus, the alarm setting time corresponds to the time at which the user goes to bed, and the alarm activation time corresponds to the time at which the user gets up.

A learning apparatus includes timer, time setting unit for setting a presentation time of a question to a user, question presenting unit for presenting the question in accordance with the setting made by the time setting unit, and external connecting unit capable of establishing a connection to an electrical communication network, wherein the external connecting unit acquires, from a center server connected to the electrical communication network, information that varies according to question answered status of other users within a group formed by a prescribed number of users each using a different learning apparatus connected to the electrical communication network.

Preferably, in the learning apparatus, the question presenting unit changes the quantity or quality of the questions according to a ranking within the group.

Preferably, in the learning apparatus, the question presenting unit does not present a question to the user if the question has already been answered correctly by some other user using one of the different learning apparatuses connected to the electrical communication network.

Preferably, the learning apparatus further includes annunciating unit for annunciating ranking status within the group.

Preferably, in the learning apparatus, the question presenting unit increases or decreases the number of questions according to the time at which to answer the questions.

A learning apparatus includes alarm setting unit for setting an alarm, alarm activating unit for activating the alarm in accordance with the setting made by the alarm setting unit, alarm stopping unit for stopping the alarm, and question presenting unit for presenting a question to a user in response to an alarm stop signal output from the alarm stopping unit, wherein in response to an alarm set signal output from the alarm setting unit, the question presenting unit presents to the user a preview of contents related to the question to be answered when the alarm is activated.

A learning apparatus includes alarm setting unit for setting an alarm, alarm activating unit for activating the alarm in accordance with the setting made by the alarm setting unit, alarm stopping unit for stopping the alarm, question presenting unit for presenting a question to a user in response to an alarm stop signal output from the alarm stopping unit, and external connecting unit capable of establishing a connection to an electrical communication network, wherein the external connecting unit acquires, from a center server connected to the electrical communication network, information that varies according to question answered status of other users each using a different learning apparatus connected to the electrical communication network.

According to the learning apparatus and the learning system using the same, the contents related to the question to be answered when the alarm is activated are presented in advance when the alarm is set; this arrangement serves to enhance the user's ability to answer the question when the alarm is activated. Specifically, when the alarm is set so as to sound when the user gets up, the learning effect for improving the correct answer percentage, etc. can be enhanced due to unconscious activity during sleep.

Further, according to the learning apparatus and the learning system using the same, by adjusting the alarm activation time according to the quantity and/or quality of the questions to be presented when the alarm is activated, the learning can be completed by the time the alarm would normally be activated, for example, by the time the user gets up and begins his daily activities. This serves to prevent any inconvenience from being caused to the user's daily activities after he gets up.

According to the learning apparatus and the learning system using the same, since the number of questions to be presented to the user is increased or decreased according to the number of alarm activations that occurred due to activation of the snooze function, the user's motivation to get up early can be enhanced.

Furthermore, according to the learning apparatus and the learning system using the same, that is, according to the learning apparatus of the present invention and the learning system using the same, because of the provision of the external connecting means capable of establishing a connection to an electrical communication network, communications can be performed with an external server via the electrical communication network, and it thus becomes possible to provide learning materials and learning methods appropriate to the user by checking the question answered status of other users. Since this achieves a learning process having a greater variety than when the user alone performs the learning, a further enhanced learning effect can be expected.

### BRIEF DESCRIPTION OF THE DRAWINGS

FIG. 1 is a schematic block diagram illustrating the configuration of a learning apparatus 1.

FIG. 2 is a schematic diagram illustrating the configuration of a learning system that uses the learning apparatus 1.

FIG. 3 is a flowchart illustrating an example of the operation of the learning apparatus 1.

FIG. 4 is a sequence diagram illustrating an example of the sequence of operations performed by the learning apparatus 1 in a question acquisition process.

FIG. 5(a) is a diagram showing an example of the structure of a presentation list.

FIG. 5(b) is a diagram showing an example of the structure of presentation information data.

FIG. 6(a) is an external view showing a display example (1) produced by the learning apparatus 1 during the question acquisition process.

FIG. 6(b) is an external view showing a display example (2) produced by the learning apparatus 1 during the question acquisition process.

FIG. 7 is a sequence diagram illustrating an example of the sequence of operations performed by the learning apparatus 1 in an alarm set process.

FIG. 8(a) is an external view showing a display example (1) produced by the learning apparatus 1 during the alarm set process.

FIG. 8(b) is an external view showing a display example (2) produced by the learning apparatus 1 during the alarm set process.

FIG. 8(c) is an external view showing a display example (3) produced by the learning apparatus 1 during the alarm set process.

FIG. 8(d) is an external view showing a display example (4) produced by the learning apparatus 1 during the alarm set process.

FIG. 8(e) is an external view showing a display example (5) produced by the learning apparatus 1 during the alarm set process.

FIG. 8(f) is an external view showing a display example (6) produced by the learning apparatus 1 during the alarm set process.

FIG. 9 is a sequence diagram illustrating an example of the sequence of operations performed by the learning apparatus 1 in an alarm activation process.

FIG. 10(a) is an external view showing a display example (1) produced by the learning apparatus 1 during the alarm activation process.

FIG. 10(b) is an external view showing a display example (2) produced by the learning apparatus 1 during the alarm activation process.

FIG. 10(c) is an external view showing a display example (3) produced by the learning apparatus 1 during the alarm activation process.

FIG. 10(d) is an external view showing a display example (4) produced by the learning apparatus 1 during the alarm activation process.

FIG. 10(e) is an external view showing a display example (5) produced by the learning apparatus 1 during the alarm activation process.

FIG. 10(f) is an external view showing a display example (6) produced by the learning apparatus 1 during the alarm activation process.

FIG. 11 is a sequence diagram illustrating an example of the sequence of operations performed by the learning apparatus 1 in a snooze operation process.

FIG. 12(a) is an external view showing a display example (1) produced by the learning apparatus 1 during the snooze operation process.

FIG. 12(b) is an external view showing a display example (2) produced by the learning apparatus 1 during the snooze operation process.

FIG. 12(c) is an external view showing a display example (3) produced by the learning apparatus 1 during the snooze operation process.

FIG. 12(d) is an external view showing a display example (4) produced by the learning apparatus 1 during the snooze operation process.

FIG. 12(e) is an external view showing a display example (5) produced by the learning apparatus 1 during the snooze operation process.

FIG. 12(f) is an external view showing a display example (6) produced by the learning apparatus 1 during the snooze operation process.

FIG. 12(g) is an external view showing a display example (7) produced by the learning apparatus 1 during the snooze operation process.

FIG. 13 is a diagram showing a display example produced on a touch panel display 13.

FIG. 14 is a schematic block diagram illustrating the configuration of an alternative learning apparatus 100.

FIG. 15 is a schematic block diagram illustrating the configuration of a further alternative learning apparatus 200.

FIG. 16 is a schematic diagram illustrating the configuration of a learning system that uses the learning apparatus 200.

FIG. 17 is a schematic block diagram illustrating the configuration of a center server 218.

FIG. 18 is a flowchart illustrating an example of the operation of the learning apparatus 200.

FIG. 19 is a sequence diagram illustrating the sequence of operations performed between the learning apparatus 200 and the center server 218 in a question acquisition process.

FIG. 20(a) is a diagram showing an example of the structure of a presentation list.

FIG. 20(b) is a diagram showing an example of the structure of presentation information data.

FIG. 21(a) is an external view showing a display example (1) produced by the learning apparatus 200 during the question acquisition process.

FIG. 21(b) is an external view showing a display example (2) produced by the learning apparatus 200 during the question acquisition process.

FIG. 22 is a sequence diagram illustrating the sequence of operations performed between the learning apparatus 200 and the center server 218 at the time of alarm activation.

FIG. 23 is a sequence diagram illustrating another example of the sequence of operations performed between the learning apparatus 200 and the center server 218 at the time of alarm activation.

FIG. 24(a) is a diagram showing a display example (1) produced by the learning apparatus 200 at the time of alarm activation.

FIG. 24(b) is a diagram showing a display example (2) produced by the learning apparatus 200 at the time of alarm activation.

FIG. 24(c) is a diagram showing a display example (3) produced by the learning apparatus 200 at the time of alarm activation.

FIG. 24(d) is a diagram showing a display example (4) produced by the learning apparatus 200 at the time of alarm activation.

FIG. 25 is a block diagram of a prior art learning apparatus.

### DESCRIPTION

A learning apparatus and a learning system using the same will be described below with reference to the drawings. It will, however, be noted that the technical scope of the present invention is not limited by any particular embodiment described herein but extends to the inventions described in the appended claims and their equivalents.

The gist of the operation of the learning apparatus 1 hereinafter described is that, when the user sets an alarm before sleep, the learning apparatus 1 presents in advance the questions to be presented when the user wakes up, or hints about the answers to the questions or a method of solving the questions. In this way, the learning apparatus 1 enhances the learning effect by assisting the user to improve his memory and enhance his logical solving ability during sleep, thereby motivating the user to learn while assisting the user to acquire the habit of getting up early.

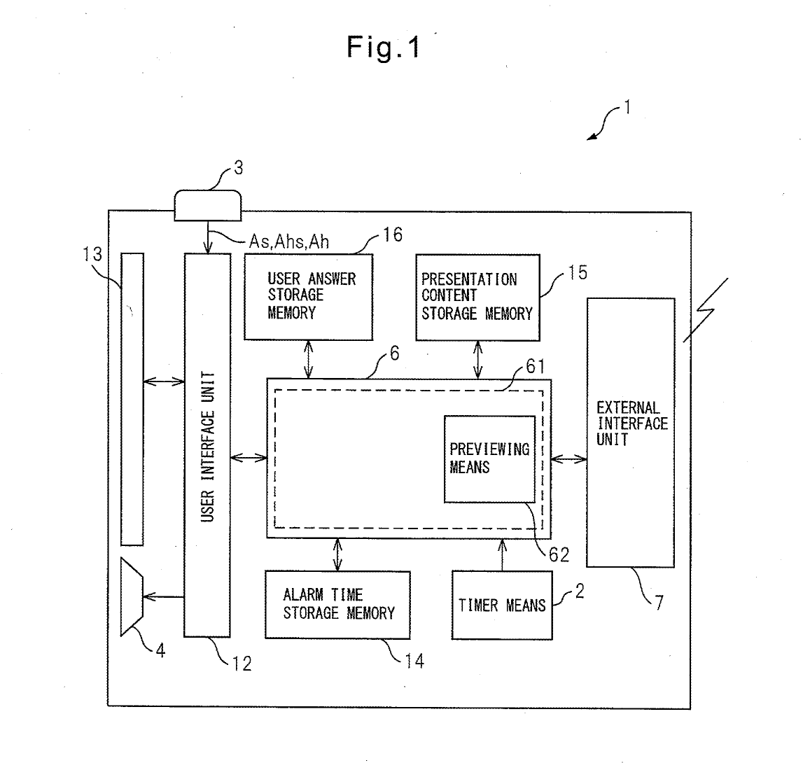

FIG. 1 is a schematic block diagram illustrating the configuration of the learning apparatus 1.

As shown in FIG. 1, the learning apparatus 1 comprises a timer means 2, an alarm button 3, a speaker 4, an overall control unit 6, an external interface unit 7, a user interface unit 12, a touch panel display 13, an alarm time storage memory 14, a presentation content storage memory 15, and a user answer storage memory 16.

The timer means 2 manages the timer function of the learning apparatus 1, and includes a time measuring function and a calendar function.

The alarm button 3 is constructed from a switch capable of both slide operation and push operation, and includes three functions: an alarm setting function, a snooze function, and an alarm stopping function. The alarm button 3 functions as a time setting means for setting the time at which to present questions to the user, as will be described later.

The alarm button 3 is constructed so that, when it is pulled up, for example, the alarm is set, and so that when it is lightly pressed, the snooze function is activated and, when it is further depressed and locked in position, the alarm setting is released and the bell sound for awakening the user stops.

The alarm button 3 outputs an alarm set signal As, a snooze signal Ahs, and an alarm stop signal Ah according to the various conditions corresponding to the alarm setting, snoozing, and alarm stopping operations. The alarm set signal As, the snooze signal Ahs, and the alarm stop signal Ah are input to the overall control unit 6 via the user interface unit 12.

The speaker 4 is an alarm activating means for producing a bell sound, etc. for awakening the user at the alarm activation time, and may include a function for presenting a voice learning guidance from the learning apparatus 1 to the user.

The overall control unit 6 comprises a CPU, a RAM, and a ROM, and controls the overall operation of the learning apparatus 1, such as logic operational decisions, input/output control, and data storage. The overall control unit 6 includes a question presenting means 61.

The question presenting means 61 includes a previewing means 62, and presents questions to the user via the user interface unit 12 or via the touch panel display 13.

The previewing means 62 functions as a preview presenting means which, when the alarm is set by the alarm button 3, outputs the contents related to the questions, that is, a preview of the questions, to be presented when the user wakes up.

The external interface unit 7 functions as an external connecting means for connecting the learning apparatus 1 to an electrical communication network by means of a router 71 via a wireless or wired link.

The touch panel display 13 includes a touch panel input function as well as an output function as a liquid crystal display, and functions not only as a means for displaying each question that the learning apparatus 1 presents to the user but also as an operating means for accepting the user's answer entered on the touch panel.

The user interface unit 12 connects the touch panel display 13, an interface between the user and the learning apparatus 1, to the overall control unit 6 in the learning apparatus 1.

The alarm time storage memory 14, the presentation content storage memory 15, and the user answer storage memory 16 are each constructed from a nonvolatile memory. The alarm time storage memory 14 stores information concerning the alarm and data such as the number of alarm activations. The presentation content storage memory 15 stores data such as information concerning the questions to be presented. The user answer storage memory 16 stores data such as information concerning the user's answers.

The learning apparatus 1 can be constructed from a personal computer or an Internet terminal. The following description is given by dealing with an example in which the learning apparatus 1 is constructed from an Internet terminal equipped with a touch panel on a liquid crystal screen.

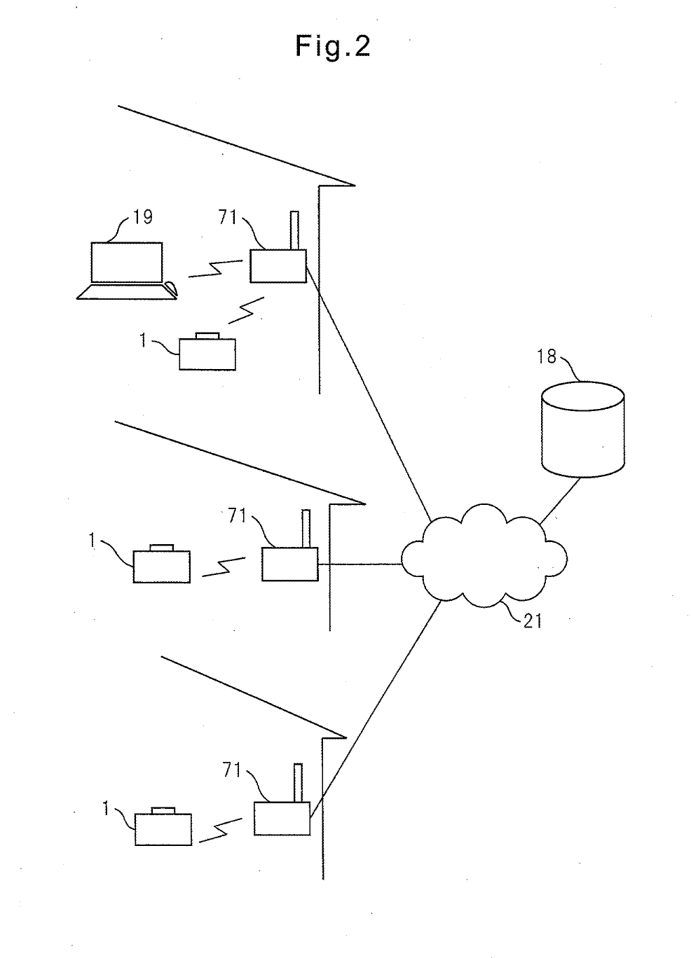

FIG. 2 is a schematic diagram illustrating the configuration of a learning system that uses the learning apparatus 1.

As illustrated in FIG. 2, the learning system includes the learning apparatus 1, located on the user's premises and connected to the router 71 for connecting to the Internet 21, and a center server 18 connected to the Internet 21. The router 71 can also be used to connect a personal computer 19 to the Internet 21.

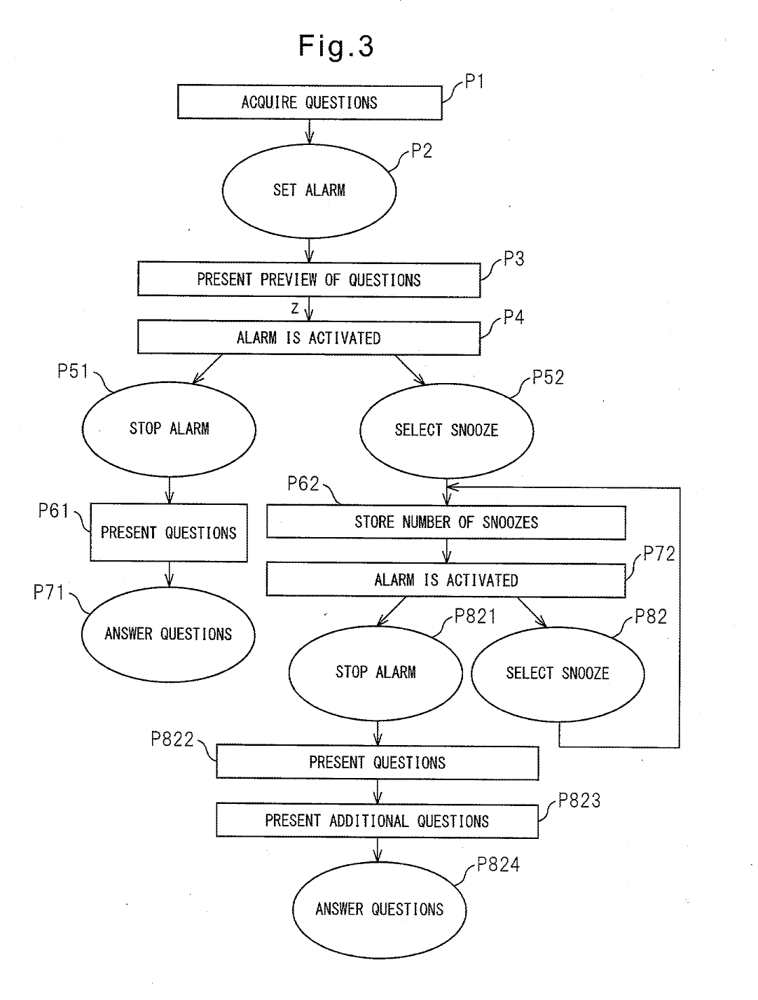

FIG. 3 is a flowchart illustrating an example of the operation of the learning apparatus 1.

In FIG. 3, the processing steps P1, P3, P4, P61, P62, P72, P822, and P823 enclosed within rectangles each represent the operation performed in the learning apparatus 1 or the center server 18, while the processing steps P2, P51, P52, P71, P82, P821, and P824 enclosed within ovals each represent the operation performed by the user 30.

In FIG. 3, the processing steps performed in the learning apparatus 1 are executed by the CPU contained in the overall control unit 6 collaborating with the various component elements of the learning apparatus 1 in accordance with a program prestored in the overall control unit 6. Further, in FIG. 3, the processing steps performed in the center server 18 are executed by the CPU (not shown) in the center server 18 collaborating with a transmitting/receiving unit (not shown), etc. in accordance with a program prestored in a memory (not shown) maintained in the center server 18. The processing steps P1 to P824 are hereinafter referred to simply as P1 to P824, respectively.

The learning apparatus 1 automatically connects to the center server 18 via the Internet 21, for example, at 12 o'clock noon when the learning apparatus 1 is not used, and acquires questions according to the registered course prespecified by the user 30 (P1: Question acquisition process).

Next, the user 30 sets the alarm of the learning apparatus 1 in order to wake up the next morning at the desired time (P2).

When the alarm is set, the learning apparatus 1 presents to the user 30 the contents related to the questions, that is, a preview of the questions, to be presented when the user 30 wakes up (P3).

“Z” shown alongside the branch from P3 means that the user 30 is sleeping.

When the alarm set time arrives, the alarm of the learning apparatus 1 is activated to sound the alarm bell (P4). After P4, there are two choices, that is, to stop the alarm or to select the snooze.

When stopping the alarm, the user 30 depresses the alarm button 3 to lock it in position and thereby stops the alarm (P51). Next, the learning apparatus 1 presents the questions specified in the registered course (P61), and the user 30 enters an answer to each question (P71). The above steps P4, P51, P61, and P71 together constitute the alarm activation process.

When the user 30 lightly presses the alarm button 3, the snooze is selected (P52). Next, the learning apparatus 1 stores a count of the number of snoozes, and updates and stores a count of the number of alarm activations that increased as a result of the selection of the snooze (P62); then, when a predetermined snooze time has elapsed, the alarm is again activated to sound the alarm bell (P72).

When the user 30 again presses the alarm button 3 lightly to select the snooze (P82), the process from P62 to P72 is repeated. That is, each time the user 30 selects the snooze, the count of the number of alarm activations that increased as a result of the selection of the snooze is updated and stored in the alarm time storage memory 14 maintained in the learning apparatus 1. The steps P4, P52, P62, P72, and P82 together constitute the snooze operation process. After P72, there are two choices, that is, to stop the alarm or to select the snooze.

When the user 30 depresses the alarm button 3 to lock it in position and thereby stops the alarm (P821), the learning apparatus 1 presents the questions specified in the registered course (P822). Next, the learning apparatus 1 presents additional questions according to the number of alarm activations (P823). Then, the user 30 enters answers not only to the questions presented according to the registered course but also the questions additionally presented (P824). In the above example, provisions are made to present the questions when the alarm is stopped, but alternatively, provisions may be made to start presenting the questions when the alarm set time arrives.

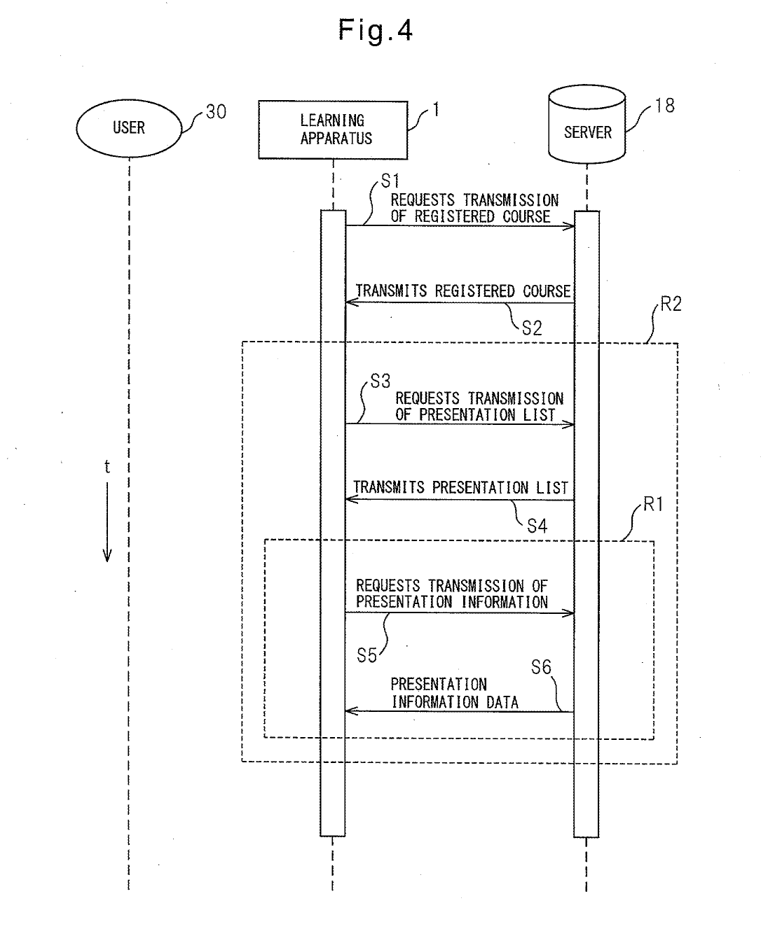

FIG. 4 is a sequence diagram illustrating an example of the sequence of operations performed by the learning apparatus 1 in the question acquisition process.

In FIGS. 4, R1 and R2 enclosed within dashed lines are program routines each comprising a plurality of operational steps. The operational steps S1, S2, . . . , Sn are hereinafter referred to simply as S1, S2, . . . , Sn, respectively.

First, the learning apparatus 1 starts communications with the center server 18, for example, at 12 o'clock noon, and transmits user ID data to the center server 18 to request transmission of the user-registered course (S1).

When the registered-course transmit request carrying the user ID data is received from the learning apparatus 1, the center server 18 transmits one or more registered-course ID data to the learning apparatus 1 (S2).

When the registered-course ID data is acquired from the center server 18, the learning apparatus 1 transmits the registered-course ID data and its associated date/time data for each registered-course ID to the center server 18 to request transmission of a presentation list (S3).

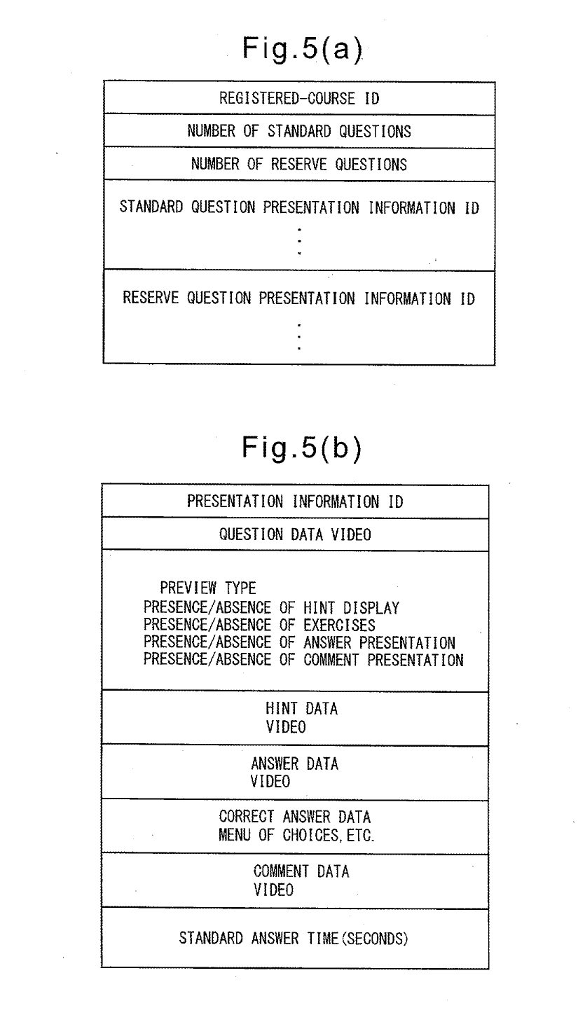

When the presentation list transmit request is received from the learning apparatus 1, the center server 18 transmits the presentation list containing a plurality of presentation information ID data to the learning apparatus 1 (S4). The presentation list comprises, for example, data shown in FIG. 5(a) (details will be described later). The learning apparatus 1 thus acquires the list of questions to be presented for the day.

Next, from among the plurality of presentation information IDs acquired from the center server 18, the learning apparatus 1 transmits the desired presentation information ID to the center server 18 to request transmission of the corresponding presentation information (S5).

When the presentation information transmit request is received from the learning apparatus 1, the center server 18 transmits the requested presentation information data (S6). The presentation information data comprises data shown in FIG. 5(b) (details will be described later). The learning apparatus 1 thus acquires the questions to be presented for the day.

In FIG. 4, the “presentation information acquisition routine R1” comprising the steps S5 and S6 is repeatedly performed until the acquisition of the questions specified in one or more presentation lists acquired in S4 is completed.

In FIG. 4, the “presentation list acquisition routine R2” comprising the steps S3 to S6 is repeatedly performed until the acquisition of the presentation lists specified by one or more registered-course IDs acquired in S2 is completed.

With the above steps S1 to S6, the questions specified in the registered course are transmitted from the center server 18 to the learning apparatus 1. After the questions in the registered course have been transmitted to the learning apparatus 1, when the alarm of the learning apparatus 1 is set the operation proceeds to an alarm set process to be described later.

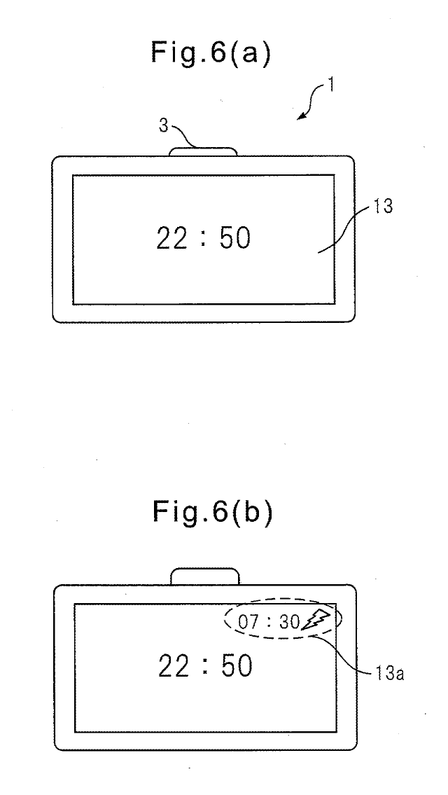

During the process from S1 to S6, the current time of day is displayed on the touch panel display 13 of the learning apparatus 1, as illustrated in FIG. 6(a) to be described later. The process from S1 to S6 automatically proceeds between the learning apparatus 1 and the center server 18 over the Internet 21.

FIG. 5 shows examples of the data structure of the information that the learning apparatus 1 acquires from the center server 18: FIG. 5(a) shows an example of the structure of the presentation list, and FIG. 5(b) shows an example of the structure of the presentation information data.

As shown in FIG. 5(a), the learning apparatus 1 acquires from the center server 18 the “presentation list” that contains the registered-course ID for identifying the registered course, the number of standard questions representing the number of standard questions specified in the registered course, the number of reserve questions, i.e., supplemental questions of the same level as the standard questions, a plurality of standard question presentation information IDs, and a plurality of reserve question presentation information IDs.

Further, as shown in FIG. 5(b), by citing the presentation list shown in FIG. 5(a), the learning apparatus 1 acquires from the center server 18 the “presentation information data” that contains the presentation information ID, question data video, preview type, hint data, answer data, correct answer data, comment data, and standard answer time (seconds) representing the average value of the answer times taken over a plurality of users. The question data video, hint data video, answer data video, correct answer data video, and comment data video are acquired only when needed. The preview type indicates the presence or absence of hint display, the presence or absence of exercises, the presence or absence of answer presentation, and the presence or absence of comment presentation in order to specify the contents related to the question to be presented in advance.

As shown in FIGS. 5(a) and 5(b), the structure of the information data exchanged between the learning apparatus 1 and the center server 18 is stratified to enhance the speed and efficiency of the communication performed between them.

FIG. 6 is an external view showing display examples produced by the learning apparatus 1 during the question acquisition process.

FIG. 6(a) shows an example when the alarm is not set; in this case, only the current time of day is displayed on the touch panel display 13. As shown in FIG. 6(a), the alarm button 3 capable of setting the alarm, snoozing, and stopping the alarm is provided on the top of the learning apparatus 1.

FIG. 6(b) shows a display example produced by the learning apparatus 1 when the alarm is set by pulling up the alarm button 3 and when no registered course is loaded. The alarm activation time and a mark indicating the alarm setting are displayed in the alarm activation time display area 13a of the touch panel display 13. The alarm activation time can be changed by touching the alarm activation time display area 13a with a finger.

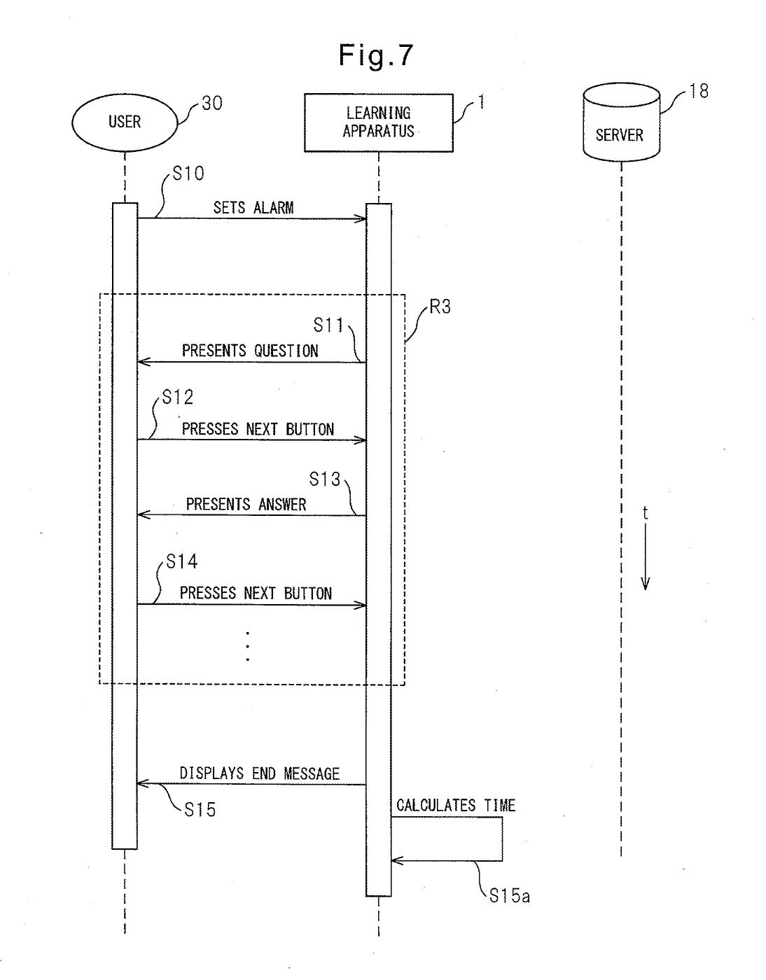

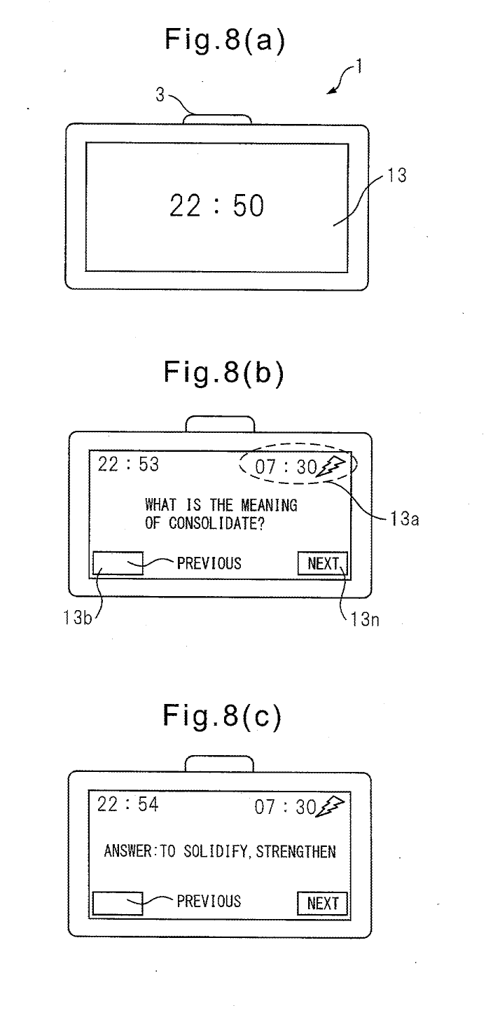

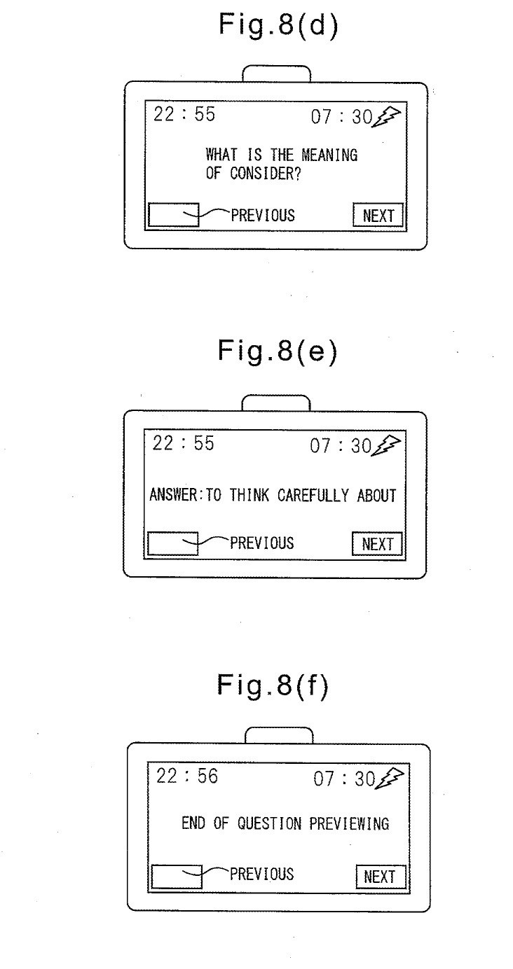

FIG. 7 is a sequence diagram illustrating an example of the sequence of operations performed between the user 30, the learning apparatus 1, and the center server 18 in the alarm set process. FIG. 8 is an external view showing display examples produced by the learning apparatus 1 during the alarm set process.

First, the user 30 sets the alarm of the learning apparatus 1 (S10). Usually, the alarm button 3 on the learning apparatus 1 is depressed and locked in position to hold the alarm in a stopped state, as shown in FIG. 8(a), but when the alarm button 3 is pulled up, as shown in FIG. 8(b), the alarm is set.

When the alarm is set by the user 30 operating the alarm button 3 on the learning apparatus 1, the alarm button 3 on the learning apparatus 1 outputs the alarm set signal As (see FIG. 1), which is supplied via the user interface unit 12 to the question presenting means 61 in the overall control unit 6.

The previewing means 62 provided in the question presenting means 61 presents, via the user interface unit 12, a preview of the first question to the touch panel display 13, as shown in FIG. 8(b) (S11). At the same time, the alarm time and the mark indicating the alarm setting are displayed in the alarm activation time display area 13a. If necessary, the user 30 can change the alarm activation time by touching the alarm activation time display area 13a with a finger.

After checking the first question, the user 30 presses the NEXT button 13n on the touch panel display 13 (S12). The NEXT button 13n is displayed on the touch panel display 13, as shown in FIG. 8(b).

When the NEXT button 13n is pressed on the touch panel display 13, the learning apparatus 1 presents an answer as a “content related to the question to be presented in advance” (S13). Other contents than the “answer presentation,” that is, “question to be solved,” “presentation of answer hint,” “how to solve the question to be answered,” “exercise on answer,” “comment on answer,” etc. can be selected as the “contents related to the question to be presented in advance,” and any one of these contents can be prespecified in the registered course. FIG. 8(c) shows an example in which the answer to the question is displayed on the touch panel display 13.

When the user 30 again presses the NEXT button 13n, the second question is displayed on the touch panel display 13, as shown in FIG. 8(d) (S14). After checking the question, the user 30 presses the NEXT button 13n, whereupon the answer to the second question is displayed on the touch panel display 13, as shown in FIG. 8(e).

By thus pressing the NEXT button 13n successively and repeating the process from S11 to S14 shown in FIG. 7, the user 30 obtains all the questions specified in the registered course and the answers to the questions.

On the other hand, when the user 30 presses the PREVIOUS button 13b on the touch panel display 13, the previous question is presented. When the user 30 keeps pressing the NEXT button 13n, the learning apparatus 1 stops the previewing of the questions in the middle of the process.

Finally, the learning apparatus 1 sends an end message to the user via the touch panel display 13 (S15). As shown in FIG. 8(f), “END OF QUESTION PREVIEWING” is displayed on the touch panel display 13 to end the alarm set process.

After S15, the overall control unit 6 in the learning apparatus 1 adjusts the activation time according to the quantity and quality of the questions to be presented at the alarm activation time, and stores the adjusted activation time in the alarm time storage memory 14. For example, if the quantity of the questions is large, the overall control unit 6 in the learning apparatus 1 adjusts the activation time so that the alarm activation time is advanced, for example, by one minute per question.

As shown in FIG. 7, the “preview presentation routine R3” comprising the steps S11 to S14 is repeatedly performed until the preview of all the questions acquired in the “question acquisition process” (see FIG. 4) is completed, unless the user 30 keeps pressing the NEXT button 13n in the middle of the process.

The purpose of the preview presentation shown in FIG. 7 is to utilize unconscious activity during sleep; that is, by presenting, immediately before sleep, a preview of information concerning the questions to be answered when the user wakes up, the invention aims to achieve the learning effect that the percentage of correct answers at the time of wakeup improves.

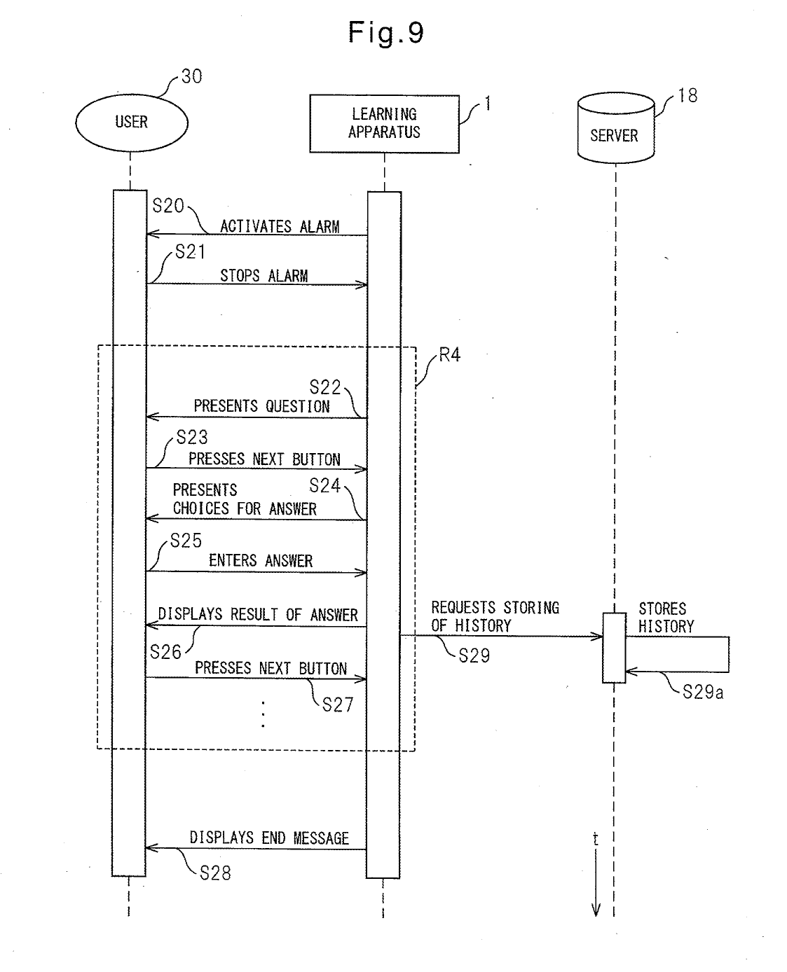

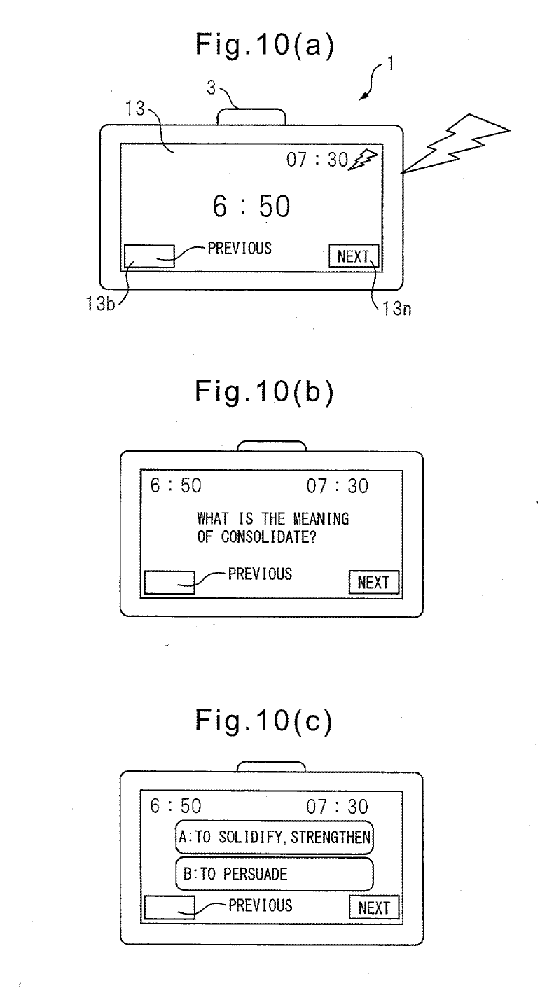

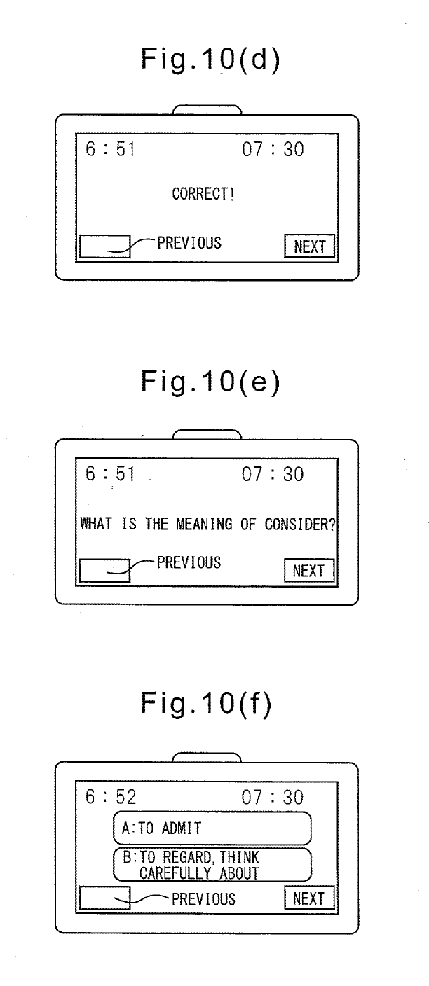

FIG. 9 is a sequence diagram illustrating an example of the sequence of operations performed by the learning apparatus 1 in the alarm activation process. FIG. 10 is an external view showing display examples produced by the learning apparatus 1 during the alarm activation process.

First, the learning apparatus 1 wakes up the user 30 by producing a bell sound through the speaker 4 before the alarm activation time stored in the alarm time storage memory 14 arrives (S20). As shown in FIG. 10(a), the current time is displayed on the touch panel display 13 of the learning apparatus 1 but, by accounting for the time the user 30 takes to solve the questions, the time displayed here has been set so as to arrive earlier than the alarm set time displayed in the alarm activation time display area 13a.

When the user 30 depresses the alarm button 3 on the learning apparatus 1 to lock it in position, the alarm stops, and thus the bell sound stops (S21). When the bell sound stops, the alarm button 3 on the learning apparatus 1 outputs the alarm stop signal Ah (see FIG. 1), which is supplied via the user interface unit 12 to the question presenting means 61 in the overall control unit 6.

Then, the question presenting means 61 produces the first question on the touch panel display 13 of the learning apparatus 1 via the user interface unit 12 (S22). As shown in FIG. 10(b), the first question is displayed on the touch panel display 13 when the alarm stops.

After checking the first question, the user 30 presses the NEXT button 13n on the touch panel display 13 to request the display of a screen for entering an answer (S23).

In response, the learning apparatus 1 displays the answer entering screen on the touch panel display 13 (S24). As shown in FIG. 10(c), the screen for entering the answer to the first question is displayed on the touch panel display 13.

The user 30 enters the answer by pressing an answer button displayed on the touch panel display 13 (S25). For example, the user 30 presses one or the other of the answer buttons A and B on the touch panel display 13 shown in FIG. 10(c).

Next, the learning apparatus 1 displays a message on the touch panel display 13 to indicate whether the user's answer is correct or not (S26). For example, a message indicating whether the answer to the first question is correct or not is displayed on the touch panel display 13, as shown in FIG. 10(d).

Next, the user 30 presses the NEXT button 13n to request the presentation of the second question (S27), and the user 30 again presses the NEXT button 13n to request the display of a screen for entering the answer to the second question, and enters the answer to the second question.

When the user presses the NEXT button 13n, as described above, the second question is displayed on the touch panel display 13, as shown in FIG. 10(e). When the user again presses the NEXT button 13n, the screen for entering the answer to the second question is displayed, as shown in FIG. 10(f), and the user 30 enters the answer by pressing one or the other of the answer buttons.

The “answer entering/storing routine R4” comprising the steps S22 to S27 shown in FIG. 9 is repeatedly performed until all the questions acquired in the “question acquisition process” (see FIG. 4) have been answered.

When all the questions specified in the registered course have been answered, the learning apparatus 1 displays an end message on the touch panel display 13 (S28). Next, the learning apparatus 1 sends a history of answers made by the user 30 to the center server 18 (S29). The center server 18 stores the history of answers (S29a). The history of answers is used, for example, for the calculation of ranking, etc. within the group to which the user 30 belongs.

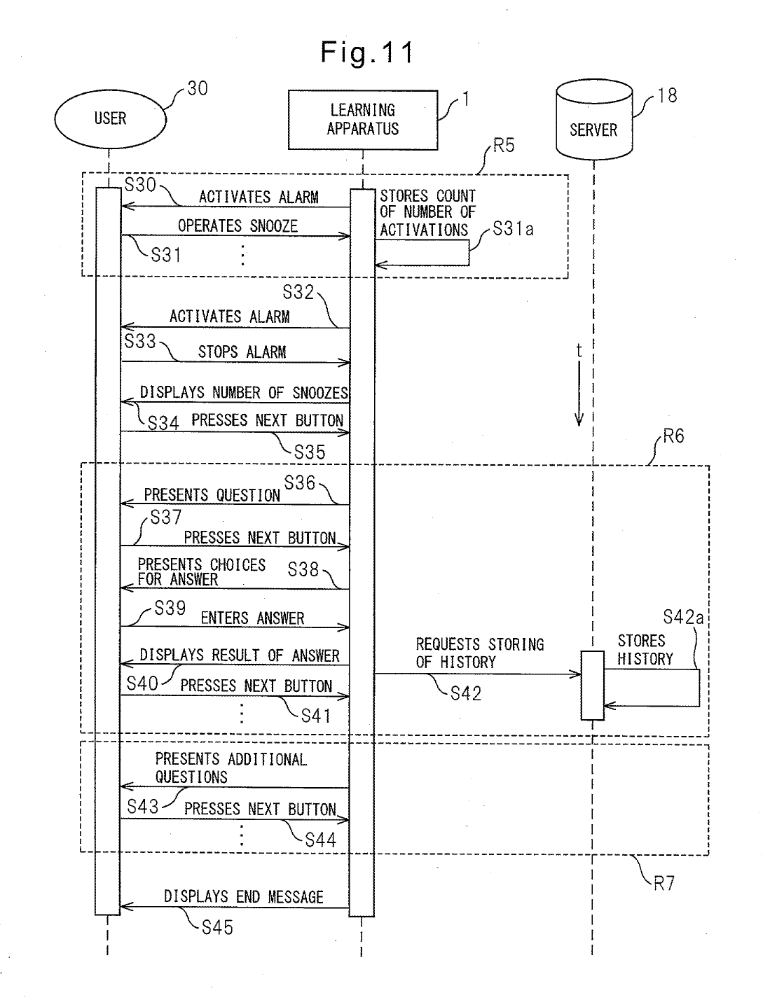

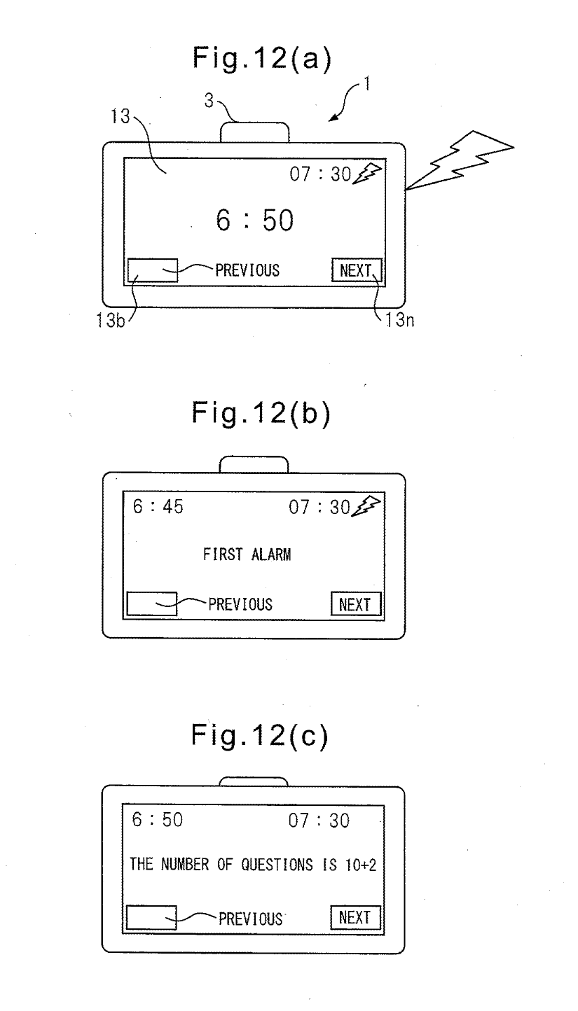

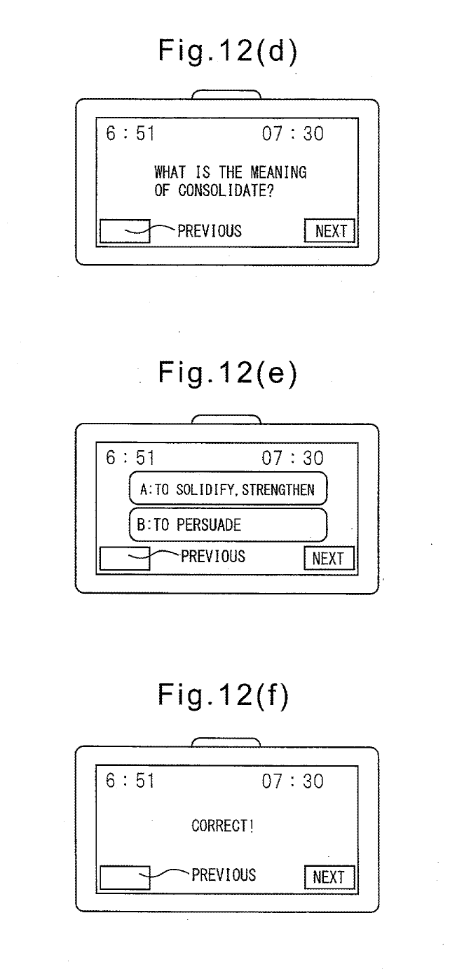

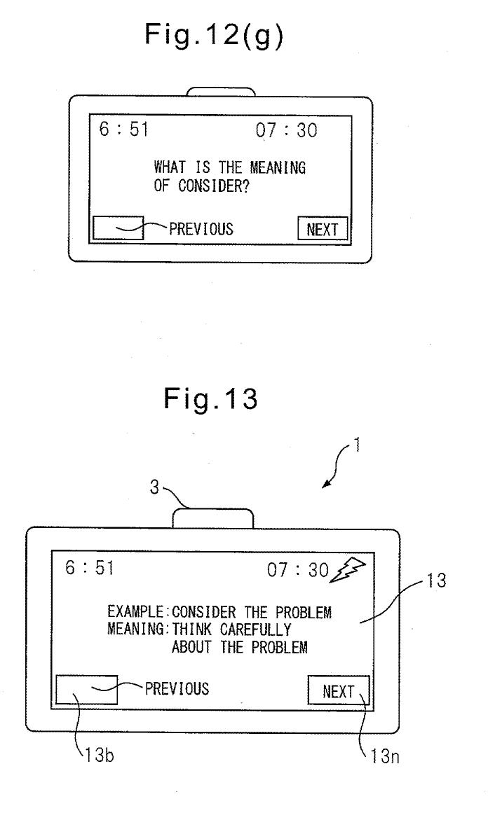

FIG. 11 is a sequence diagram illustrating an example of the sequence of operations performed by the learning apparatus 1 in the snooze operation process. FIG. 12 is an external view showing display examples produced by the learning apparatus 1 during the snooze operation process.

In FIG. 11, the learning apparatus 1 wakes up the user 30 by producing a bell sound through the speaker 4 when the alarm activation time stored in the alarm time storage memory 14 arrives (S30). As shown in FIG. 12(a), the current time is displayed on the touch panel display 13 of the learning apparatus 1, but the current time is earlier than the alarm set time displayed in the alarm activation time display area 13a.

When the user 30 presses the alarm button 3 lightly to select the snooze, the bell sound stops (S31). The learning apparatus 1 increments by one the count of the number of alarm activations stored in the alarm time storage memory 14 shown in FIG. 1 (S31a). Then, as shown in FIG. 12(b), an indication “FIRST ALARM” indicating the count of the number of alarm activations that increased as a result of the selection of the snooze is displayed on the touch panel display 13 of the learning apparatus 1.

Though not shown in FIG. 12(b), it is also possible to display the snooze time, for example, “+3 minutes”, in the alarm activation time display area 13a of the touch panel display 13.

The snooze is a function that temporarily stops the alarm bell sound and then causes the alarm bell to sound again after a preset time, for example, after three minutes. When the alarm bell sounds again, for example, after three minutes, and when the user 30 again presses the alarm button 3 lightly to select the snooze, the count of the number of alarm activations stored in the alarm time storage memory 14 is once again updated.

As shown in FIG. 11, the “snooze operation routine R5” comprising the steps S30 to S31a is repeatedly performed until the user 30 stops selecting the snooze and stops the alarm.

Next, the alarm bell of the learning apparatus 1 sounds (S32). The user 30 stops the alarm by depressing the alarm button 3 to lock it in position (S33). The learning apparatus 1 displays the number of added questions and, if necessary, the number of alarm activations, etc. (S34). As shown in FIG. 12(c), a message “THE NUMBER OF QUESTIONS IS 10+2” is produced on the display to notify the user that the number of added questions is two.

When the user 30 presses the NEXT button 13n on the touch panel display 13 (S35), the first question specified in the registered course is presented, as shown in FIG. 12(d). The process from S36 to S42a is the same as the previously described “alarm activation process,” and therefore the description will not be repeated here.

FIGS. 12(e) to 12(g) show the display examples produced on the touch panel display 13 in S36 to S42a, but since these examples are the same as the corresponding examples in the “alarm activation process,” the description will not be repeated here.

The “answer entering/storing routine R6” comprising the steps S36 to S42a shown in FIG. 11 is repeatedly performed until all the questions acquired from the registered course in the “question acquisition process” (see FIG. 4) have been answered.

When the presentation of the questions specified in the registered course is completed, the learning apparatus 1 presents additional questions according to the number of alarm activations. The additional questions are selected from the set of reserve questions shown in FIG. 5(a).

The set of reserve questions comprises a plurality of supplemental questions of the same level as the standard questions specified in the registered course, and is held in the center server 18. The learning apparatus 1 presents additional questions according to the number of alarm activations (S43 and S44).

As shown in the “snooze additional question presentation routine R7” of FIG. 11, the presentation of the question, the entering of the answer, and the display indicating whether the answer is correct or not are repeated for each additional question, but since the operation is the same as that of the “answer entering/storing routine R6,” the description will not be repeated here.

The sequence of operations performed between the learning apparatus 1, the user 30, and the center server 18 in the “snooze additional question presentation routine R7” and the display examples produced on the touch panel display 13 of the learning apparatus 1 are the same as those in the previously described process, and therefore the description will not be repeated here. When the presentation of the additional questions is completed, the learning apparatus 1 produces an end message (S45).

As described above, by employing the method in which the contents related to the questions to be presented when the user 30 wakes up are presented in advance to the user 30 when the alarm is set, the learning apparatus 1 can enhance the learning effect.

FIG. 13 is a diagram showing a display example produced on the touch panel display 13.

As previously described, the contents related to the questions, that is, the type of question preview, can be selected from among “question to be solved,” “answer presentation,” “presentation of answer hint,” “how to solve the question to be answered,” “exercise on answer,” “comment on answer,” etc. FIG. 13 shows an example in which “answer and comment” is selected as the type of question preview. As shown in FIG. 13, an usage example of the word in question and the comment on the usage example are produced on the touch panel display 13.

In the snooze function described above, provisions are made, for example, to increase the number of questions as the number of alarm activations increases as a result of snooze activation. Then, the user 30 may want to reduce the number of questions to be answered by reducing the number of times the snooze function is activated; hence, the effect of enhancing the user's motivation to get up early can be expected.

According to the learning apparatus 1 shown in FIGS. 1 to 13, by setting the alarm before sleep, the user is allowed to know in advance the answers or hints about the answers to the questions expected to be presented when he wakes up, or the method of solving the questions, or examples of model answers. This not only serves to motivate the user to learn, but at the same time serves to assist the user to improve his memory and enhance his logical solving ability during sleep, while also assisting the user to acquire the habit of getting up early.

In the flowchart shown in FIG. 3, the preview of the questions was presented (see P3) after the alarm was set (see P2). Alternatively, the overall control unit 6 in the learning apparatus 1 may present the preview of the questions at appropriate timing (see P3) and may perform control so that the alarm setting (see P2) will not be completed until the user finishes solving all the questions presented in the preview.

In the flowchart shown in FIG. 3, the alarm setting (see P2) was followed by the presentation of the preview of the questions (see P3). Alternatively, the overall control unit 6 in the learning apparatus 1 may perform control so that the preview of the questions (see P3) will not be presented unless the time to set the alarm is before sleep (for example, 9 PM to 1 AM).

In the flowchart shown in FIG. 3, the questions to be presented in the preview (see P3) and the questions to be presented later (see P61) were fixed in advance. Alternatively, the overall control unit 6 in the learning apparatus 1 may perform control so that only the questions that the user was able to answer in the preview (see P3) will be presented later.

In the flowchart shown in FIG. 3, the questions to be presented in the preview (see P3) and the questions to be presented later (see P61) were fixed in advance. However, the quantity or quality of the questions to be presented later may be changed according to the length of the user's sleep. The length of the user's sleep can be calculated from the difference between the time of alarm setting and the time for which the alarm is set.

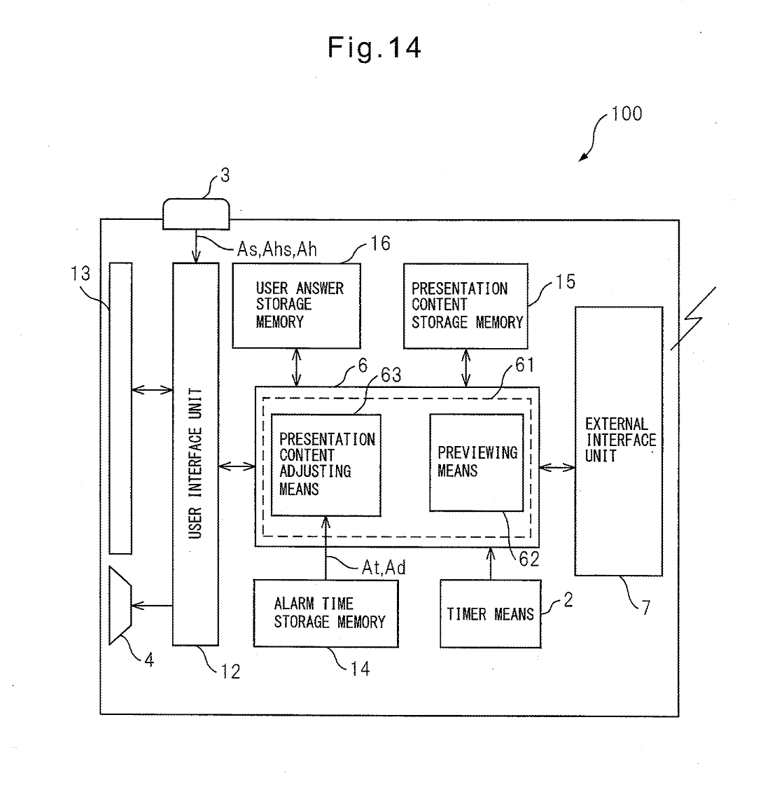

FIG. 14 is a schematic block diagram illustrating the configuration of an alternative learning apparatus 100.

The alternative learning apparatus 100 shown in FIG. 14 differs from the learning apparatus 1 shown in FIG. 1 in that the question presenting means 61 provided in the overall control unit 6 in the learning apparatus 100 includes a presentation content adjusting means 63. Otherwise, the configuration of the learning apparatus 100 is the same as that of the learning apparatus 1, and therefore, the same component elements are designated by the same reference numerals, and the description of such component elements will not be repeated here.

The presentation content adjusting means 63 in the alternative learning apparatus 100 has the function of adjusting the quantity or quality of the questions to be presented, based on the alarm setting time and the alarm activation time. For example, when the length of sleep is short, the quantity or quality of the questions to be presented is reduced, while on the other hand, when the length of sleep is long, the quantity or quality of the questions to be presented is increased; by so doing, the learning effect can be enhanced.

More specifically, the presentation content adjusting means 63 adjusts the quantity or quality of the questions to be presented, based on the alarm setting time At and alarm activation time Ad stored in the alarm time storage memory 14.

The presentation content adjusting means 63 makes settings such that, if the length of sleep corresponding to the difference between the alarm setting time At and the alarm activation time Ad is longer than the length of average sleep (threshold), the number of questions to be presented is increased and, if the length of sleep is shorter than the length of average sleep, the number of questions to be presented is reduced. Further, the presentation content adjusting means 63 makes settings such that, if the alarm setting time At is in the predawn time segment, the quality of the questions to be presented is reduced and, if the alarm setting time At and the alarm activation time Ad are both in the early midnight time segment, the quality of the questions to be presented is increased. The method of adjustment is not limited to the above examples, but other suitable methods may be employed.

As described above, according to the learning apparatus 1 and 100, when the alarm is set before sleep, the answers or hints about the answers to the questions expected to be presented when the user wakes up, or the method of solving the questions, or examples of model answers, are presented in advance to the user, which serves to enhance the user's motivation for learning. Furthermore, the learning apparatus 1 and 100 can assist the user to improve his memory and enhance his logical solving ability during sleep. According to the alternative learning apparatus 100, the learning effect can be enhance in a more effective manner.

The learning apparatus 1 and 100 have each been described above by taking as an example the case where the apparatus is used by connecting to the Internet. However, the learning apparatus 1 and 100 need not be limited to this particular example, but may be implemented as a so-called stand-alone type which is not connected to the Internet. When implementing the apparatus as a stand-along type, the functions to be provided by the center server 18 need only be incorporated in the learning apparatus 1 or 100.

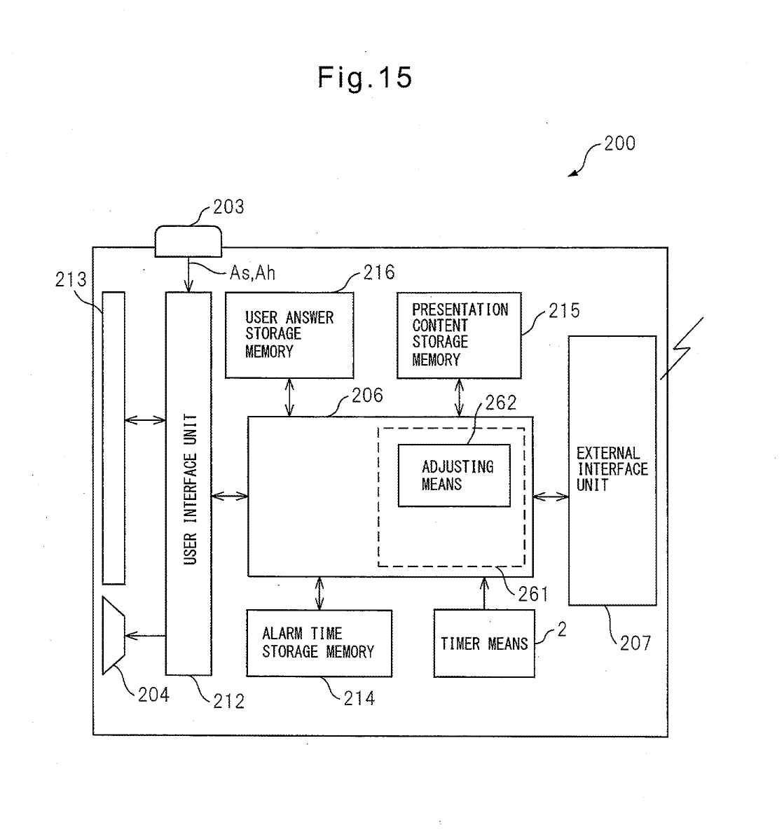

FIG. 15 is a schematic block diagram illustrating the configuration of a further alternative learning apparatus 200.

Briefly, the operation of the learning apparatus 200 described hereinafter is such that when the alarm sounds, and the user stops the alarm, the questions specified in the registered course are presented sequentially. Further, in the learning apparatus 200, the quantity and/or quality of the questions change according to the results of the answers made by the user or according to the user's results compared with other users' results, and the learning effect can be enhanced while the user is operating the apparatus as if he were playing a game.

As shown in FIG. 15, the learning apparatus 200 comprises a timer means 202, an alarm button 203, a speaker 204, an overall control unit 206, an external interface unit 207, a user interface unit 212, a touch panel display 213, an alarm time storage memory 214, a presentation content storage memory 215, and a user answer storage memory 216.

The timer means 202 manages the timer function of the learning apparatus 200, and includes a time measuring function and a calendar function.

The alarm button 203 is constructed from a switch capable of both slide operation and push operation, and includes three functions: an alarm setting function, a snooze function, and an alarm stopping function.

The alarm button 203 is constructed so that, when it is pulled up, for example, the alarm is set, and so that when it is lightly pressed, the snooze function is activated and, when it is further depressed and locked in position, the alarm setting is released and the bell sound for awakening the user stops.

The alarm button 203 outputs an alarm set signal As and an alarm stop signal Ah according to the various conditions corresponding to the alarm setting and alarm stopping operations. The alarm set signal As and the alarm stop signal Ah are input to the overall control unit 206 via the user interface unit 212.

The speaker 204 is an alarm activating means for producing a bell sound, etc. for awakening the user at the alarm activation time, and may include a function for presenting a voice learning guidance from the learning apparatus 200 to the user.

The overall control unit 206 comprises a CPU, a RAM, and a ROM, and controls the overall operation of the learning apparatus 200, such as logic operational decisions, input/output control, and data storage. The overall control unit 620 includes a question presenting means 261.

The question presenting means 261 includes an adjusting means 262, and presents questions to the user via the user interface unit 212 or via the touch panel display 213.

The adjusting means 262 has the function of adjusting the quality and quantity of the questions to be presented when the alarm is stopped.

The external interface unit 207 connects the learning apparatus 200 to an electrical communication network by means of a router 271 via a wireless or wired link.

The touch panel display 213 includes a touch panel input function as well as an output function as a liquid crystal display, and not only displays each question that the learning apparatus 200 presents to the user but also accepts the user's answer entered on the touch panel.

The user interface unit 212 connects the touch panel display 213, an interface between the user and the learning apparatus 200, to the overall control unit 206 in the learning apparatus 200.

The alarm time storage memory 214, the presentation content storage memory 215, and the user answer storage memory 216 are each constructed from a nonvolatile memory. The alarm time storage memory 214 stores information concerning the alarm and data such as the number of alarm activations. The presentation content storage memory 215 stores data such as information concerning the questions to be presented. The user answer storage memory 216 stores data such as information concerning the user's answers.

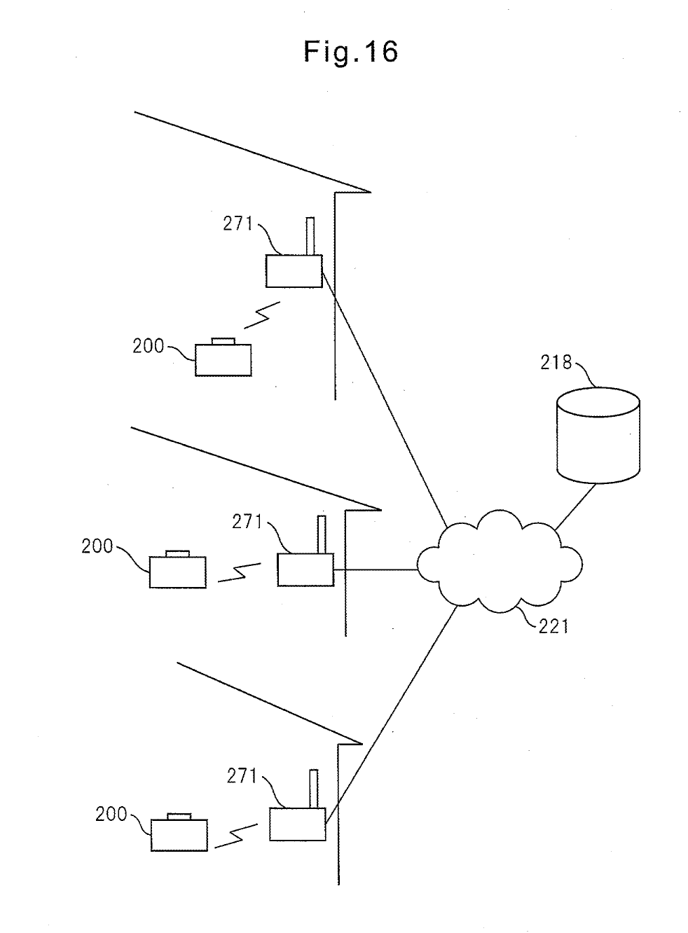

FIG. 16 is a schematic diagram illustrating the configuration of a learning system that uses the learning apparatus 200.

As illustrated in FIG. 16, the learning system includes the learning apparatus 200, located on the user's premises and connected to the router 271 for connecting to the Internet 221, and a center server 218 connected to the Internet 221.

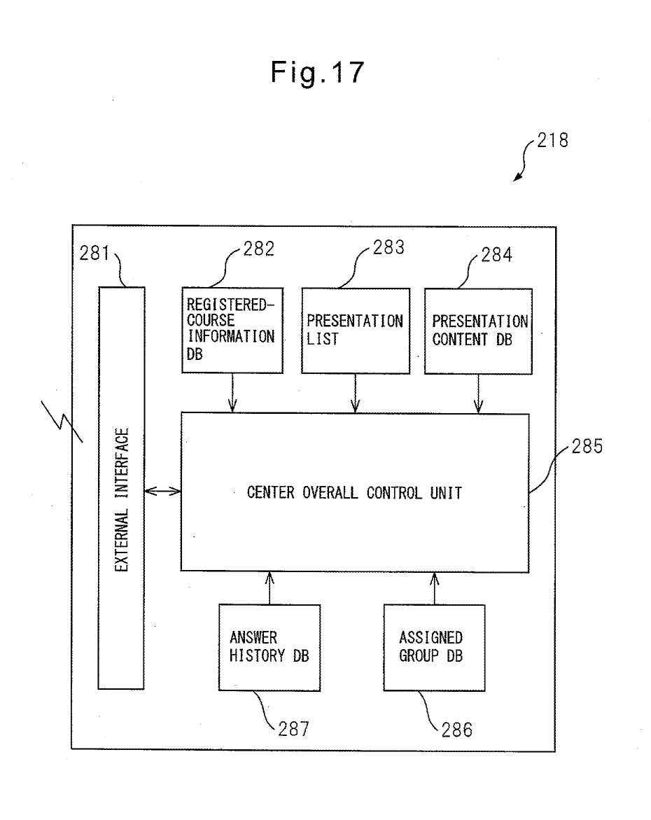

FIG. 17 is a schematic block diagram illustrating the configuration of the center server 218.

The center server 218 comprises an external interface 281, a registered-course information DB (database) 282, a presentation list DB 283, a presentation content DB 284, a center overall control unit 285, an assigned group DB 286, and an answer history DB 287.

The external interface 281 connects the center server 218 to the Internet 221 via an electrical communication network to perform data communication with the learning apparatus 200 of the user.

The system is constructed so that by searching the registered-course information DB 282 using the user ID (user verification), the ID of the course to which the user is registered, that is, the registered-course ID, can be obtained.

The system is constructed so that by searching the presentation list DB 283 using the registered-course ID and date/time information, the ID of the contents to be presented, that is, the presentation information ID, can be obtained.

The system is constructed so that by searching the presentation content DB 284 using the presentation information ID, the presentation information data can be obtained.

The center overall control unit 285 comprises a CPU, a ROM, a RAM, and various other recording media, and controls the overall operation of the center server 218.

The center overall control unit 285 receives a registered-course transmit request carrying the user ID from the learning apparatus 200, searches the registered-course information DB 282 for the registered course of the user identified by the user ID, and returns one or more registered-course IDs as search results to the learning apparatus 200.

The center overall control unit 285 receives a presentation list request carrying the registered-course ID from the learning apparatus 200, searches the presentation list DB 283 for presentation information IDs designating a plurality of questions to be presented in the registered course, and returns a presentation list containing a plurality of presentation information IDs as search results to the learning apparatus 200.

The center overall control unit 285 receives a presentation information request carrying the presentation information IDs from the learning apparatus 200, searches the presentation content DB 284 for the corresponding presentation information data, and returns the presentation information data as search results to the learning apparatus 200.

The center overall control unit 285 receives a user answer history store request carrying the date/time, user ID, user's answers, and presentation information IDs from the learning apparatus 200, and stores the answer history in the answer history DB.

When a ranking order report request carrying the user ID is received from the learning apparatus 200, the center overall control unit 285 searches the assigned group DB 286 using the user ID, and identifies the users belonging to the same group.

The center overall control unit 285 searches the answer history DB 287 for the answer histories of the users belonging to the same group, calculates the ranking based on the search results, and returns the obtained ranking to the learning apparatus 200.

When a correct answer percentage report request carrying the user ID is received from the learning apparatus 200, the center overall control unit 285 calculates the correct answer percentage ranking within the user's group in the same manner as above, and returns the correct answer percentage ranking to the learning apparatus 200.

When a status presentation request carrying the user ID and presentation information ID is received from the learning apparatus 200, the center overall control unit 285 searches the assigned group DB 286 using the user ID, and identifies the users belonging to the same group. Then, the center overall control unit 285 searches the answer history DB 287 using the presentation information ID, checks whether the question has already been answered correctly by any one of the identified users, and returns the result of the checking to the learning apparatus 200.

In the learning system using the learning apparatus 200 shown in FIGS. 15 to 18, it is assumed that the ranking information that the center server 218 returns to the learning apparatus 200 includes the ranking information only for the user that requested it, and does not include the ranking information for the other users in the same group. However, provisions may be made so that the ranking information includes the ranking information for all the users in the same group.

The date/time, the user ID, the user's answers, and the presentation information IDs are information items that are transmitted from the learning apparatus 200 to the center server 218. Further, the contents of the DBs other than the answer history DB, that is, the contents of the presentation list DB 283, the presentation content DB 284, and the assigned group DB 286, may be written in advance, for example, at the beginning of the year.

The assigned group DB 286 stores the user ID and the assigned group ID as a pair, and is used to determine the range within which to calculate the ranking, etc. Using the assigned group DB 286, the assigned group ID can be searched for by the user ID, and conversely, the user ID can be searched for by the assigned group ID.

The answer history DB 287 stores an answer history that contains the user's date/time, the user ID, the presentation information IDs, and the user's answers.

The answer history is used to calculate the ranking information, that is, the ranking order and the correct answer percentage ranking, within the group.

The learning apparatus 200 can be constructed from a personal computer or an Internet terminal. The following description is given by dealing with an example in which the learning apparatus 200 is constructed from an Internet terminal equipped with a touch panel on a liquid crystal screen.

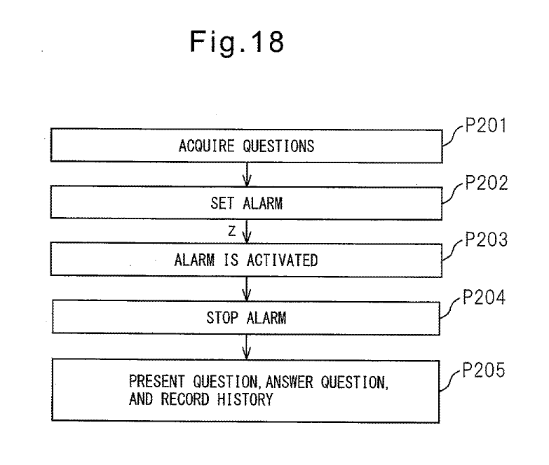

FIG. 18 is a flowchart illustrating an example of the operation of the learning apparatus 200.

In FIG. 18, the processing steps performed in the learning apparatus 200 are executed by the CPU contained in the overall control unit 206 collaborating with the various component elements of the learning apparatus 200 in accordance with a program prestored in the overall control unit 206. Further, in FIG. 18, the processing steps performed in the center server 218 are executed by the CPU in the center overall control unit 285 collaborating with the various component members (see FIG. 17) in accordance with a program prestored in a memory maintained in the center overall control unit 285. The processing steps P201 to P205 are hereinafter referred to simply as P201 to P205, respectively.

The learning apparatus 200 automatically connects to the center server 218 via the Internet 221, for example, at 12 o'clock noon when the learning apparatus 200 is not used, and acquires questions according to the registered course stored in the registered-course information DB 282 maintained in the center server 218 shown in FIG. 17 (P201: Question acquisition process).

The learning apparatus 200 stores the acquired question data in the presentation content memory 215 maintained in the learning apparatus 200 shown in FIG. 15.

Next, the user 230 sets the alarm of the learning apparatus 200 in order to wake up at the desired time (P202). “Z” shown alongside the branch from P202 means that the user 230 is sleeping.

Next, the learning apparatus 200 wakes up the user by producing a bell sound a predetermined time earlier than the alarm set time by considering the questions to be presented for the day (P203).

Then, the user 230 stops the alarm by depressing the alarm button 203 to lock it in position (P204).

Next, the learning apparatus 200 presents each question specified in the registered course, the user 230 enters an answer to the question, and the learning apparatus 200 sends the answer history to the center server 218 via the electrical communication network (P205). The answer history received by the center server 218 is stored in the answer history DB in FIG. 17, and is used to calculate the order or ranking within the group to which the user 230 belongs. The process of presenting the question, answering the question, and recording the answer history in P205 is repeated as many times as the specified number of questions.

When the user 230 belongs to a group formed in advance with a plurality of users, the learning apparatus 200 using the adjusting means 62 in the question presenting means 261 in FIG. 15 adjusts the quantity and quality of the questions to be presented, according to the results within the group and the time to get up.

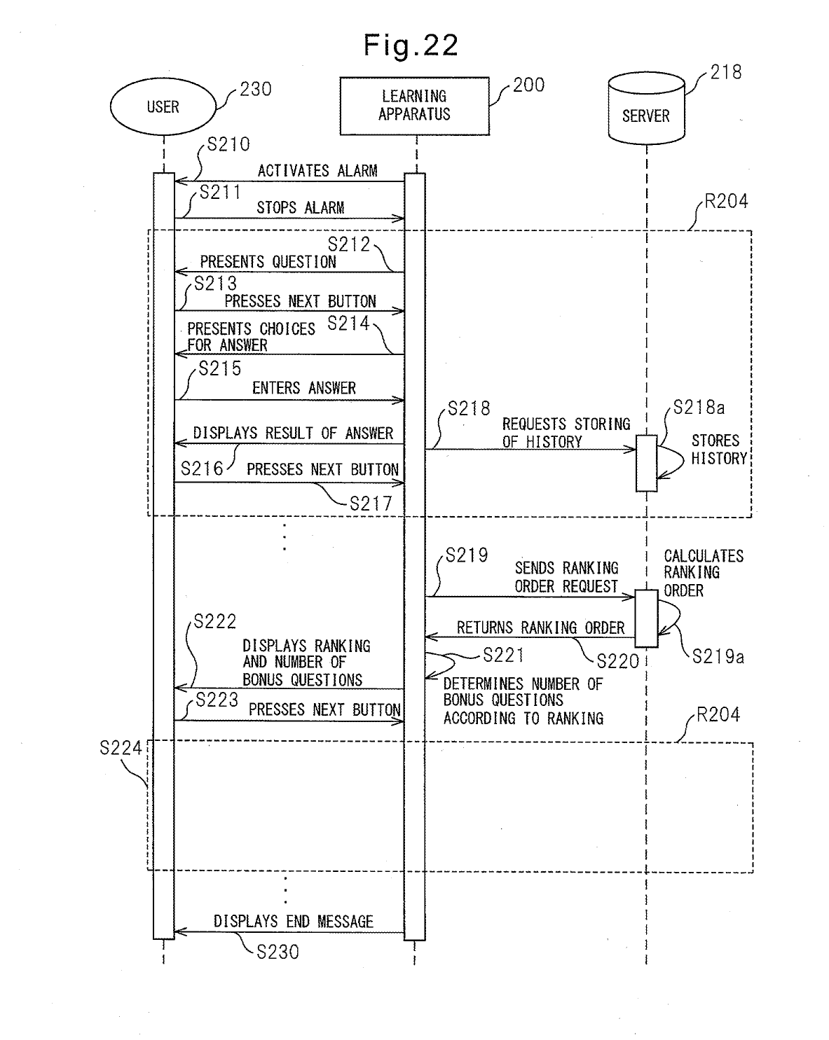

The method of adjusting the quantity and quality of the questions will be described later with reference to FIG. 22.

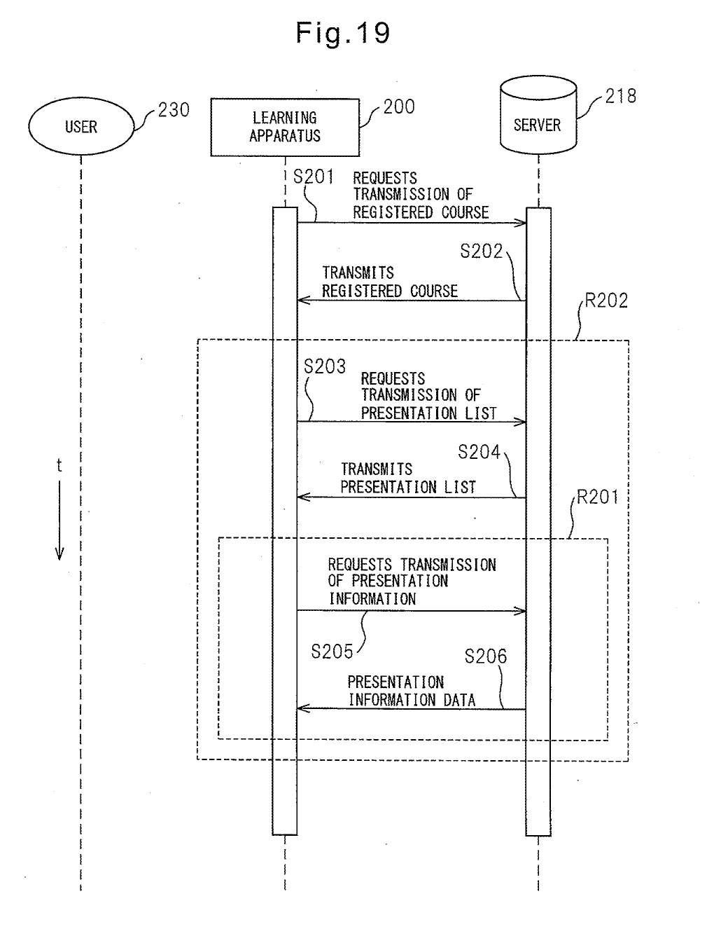

FIG. 19 is a sequence diagram illustrating the sequence of operations performed between the learning apparatus 200 and the center server 218 in the question acquisition process.

In FIGS. 19, R201 and R202 enclosed within dashed lines are program routines each comprising a plurality of operational steps. The operational steps S201, S202, . . . , Sn are hereinafter referred to simply as S201, S202, . . . , Sn, respectively.

First, the learning apparatus 200 starts communications with the center server 218, for example, at 12 o'clock noon, and transmits user ID data to the center server 218 to request transmission of the user-registered course (S201).

When the registered-course transmit request carrying the user ID data is received from the learning apparatus 200, the center server 218 refers to the contents of the registered-course information DB 282 and transmits to the learning apparatus 200 one or more registered-course IDs for the user identified by the user ID (S202).

When the registered-course ID data is acquired from the center server 218, the learning apparatus 200 transmits the registered-course ID data and its associated date/time data for each registered-course ID to the center server 218 to request transmission of a presentation list (S203).

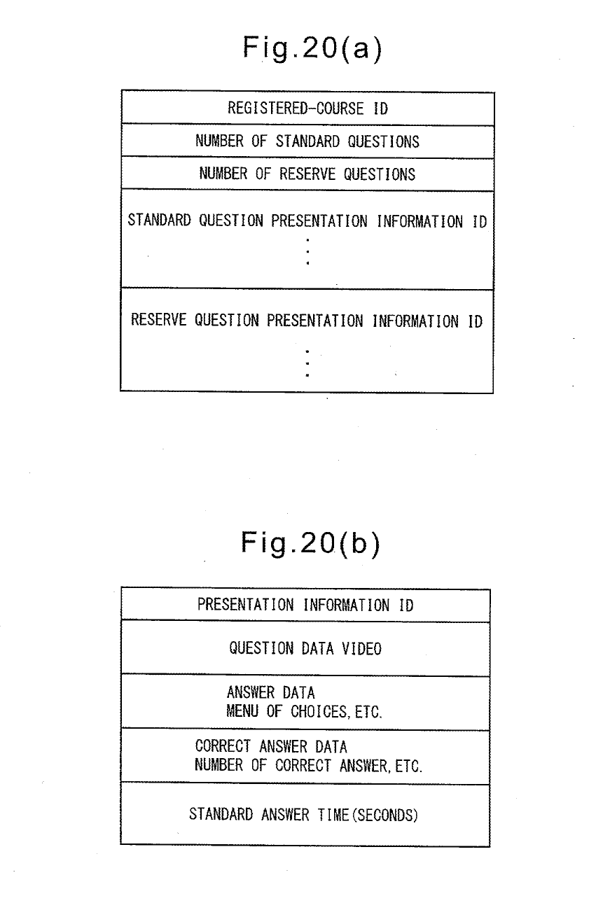

When the presentation list transmit request is received from the learning apparatus 200, the center server 218 transmits the presentation list containing a plurality of presentation information ID data to the learning apparatus 200 (S204). The presentation list will be described later with reference to FIG. 20(a).

Next, from among the plurality of presentation information IDs acquired from the center server 218, the learning apparatus 200 transmits the presentation information IDs sequentially, one at a time, to the center server 218 to request transmission of the corresponding presentation information (S205).

When the presentation information transmit request is received from the learning apparatus 200, the center server 218 searches the presentation content DB for the presentation information data corresponding to the presentation information ID carried in the request, and transmits the presentation information data to the learning apparatus 200 (S206). The presentation information data will be described later with reference to FIG. 20(b).

The “presentation information acquisition routine R201” comprising the steps S205 and S206 shown in FIG. 19 is repeatedly performed until the acquisition of the questions specified in one or more presentation lists acquired in S204 is completed.

The “presentation list acquisition routine R202” comprising the steps S203 to S206 shown in FIG. 19 is repeatedly performed until the acquisition of the presentation lists specified by one or more registered-course IDs acquired in S202 is completed.

With the above steps S201 to S206, the questions specified in the registered course are transmitted from the center server 218 to the learning apparatus 200 which thus acquires the questions to be presented for the day.

FIG. 20 is a diagram showing the data structure of the various kinds of information that the learning apparatus 200 acquires from the center server 218: FIG. 20(a) shows the structure of the presentation list, and FIG. 20(b) shows the structure of the presentation information data.

In S204, the learning apparatus 200 acquires the list of the questions to be presented for the day. As shown in FIG. 20(a), the presentation list contains the registered-course ID, the number of standard questions contained in the presentation list, the number of reserve questions, the standard question presentation information IDs the number of which corresponds to the number of standard questions, and the reserve question presentation information IDs the number of which corresponds to the number of reserve questions. The standard questions are the questions that are always presented to the user, while the reserve questions are the questions about which decisions as to whether or not to present the questions are made for each user, as will be described later.

As shown in FIG. 20(b), the presentation information data contains the presentation information ID, question data, answer data, correct answer data, and standard answer time. The question data is, for example, video data which is reproduced when the learning apparatus 200 presents a question. The answer data is, for example, video data which is displayed when the learning apparatus 200 prompts the user to enter an answer. The correct answer data is data that indicates the correct answer to the question and is presented, for example, in the form of a menu of choices from which to select the correct answer. The standard answer time indicates the time expected to be required to solve the question, and is expressed, for example, in seconds. The learning apparatus 200 refers to the standard answer time when adjusting the alarm activation time.

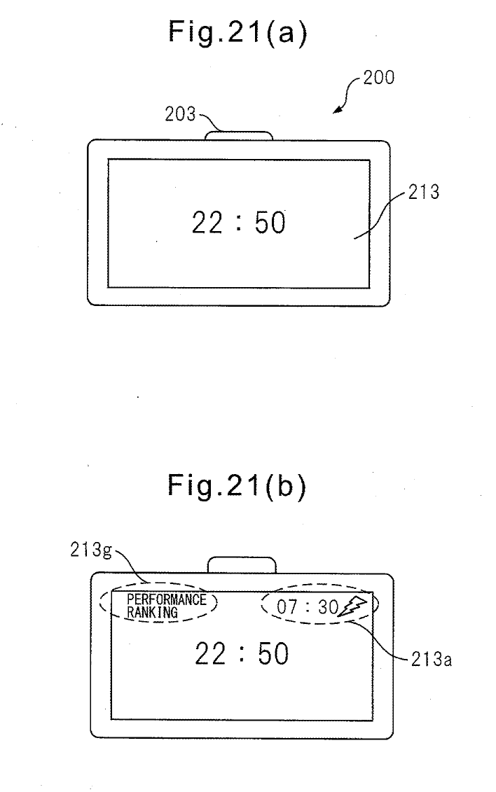

FIG. 21 is an external view showing display examples produced by the learning apparatus 200. FIG. 21(a) shows a display example produced by the learning apparatus 200 when the alarm is not set; in this case, only the current time of day is displayed on the touch panel display 213.

The alarm button 203 capable of setting the alarm, snoozing, and stopping the alarm is provided on the top of the learning apparatus 200.

During the process from S201 to S206, the current time is displayed on the touch panel display 213 of the learning apparatus 200, as illustrated in FIG. 21(a). The process from S201 to S206 automatically proceeds between the learning apparatus 200 and the center server 218 over the Internet 221.

FIG. 21(b) shows a display example produced by the learning apparatus 200 when the alarm is set by puling up the alarm button 203 and when no registered course is loaded. As shown in FIG. 21(b), the alarm activation time and a mark indicating the alarm setting are displayed in the alarm activation time display area 213a of the touch panel display 213. The alarm activation time can be changed by touching the alarm activation time display area 213a.

Further, as shown in FIG. 21(b), it is also possible to provide the touch panel display 213 with an intra-group ranking display area 213g for displaying the performance ranking within the group to which the user belongs.

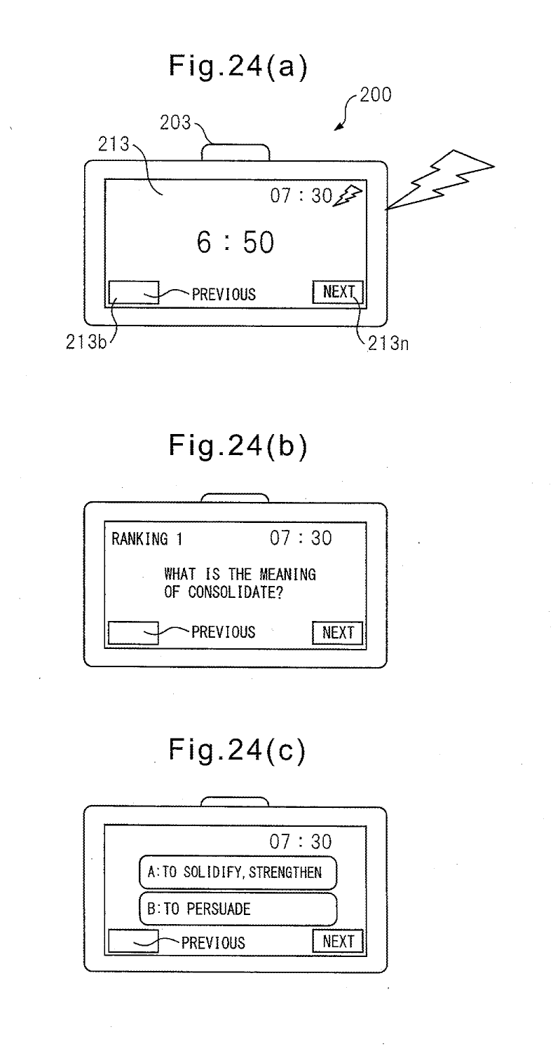

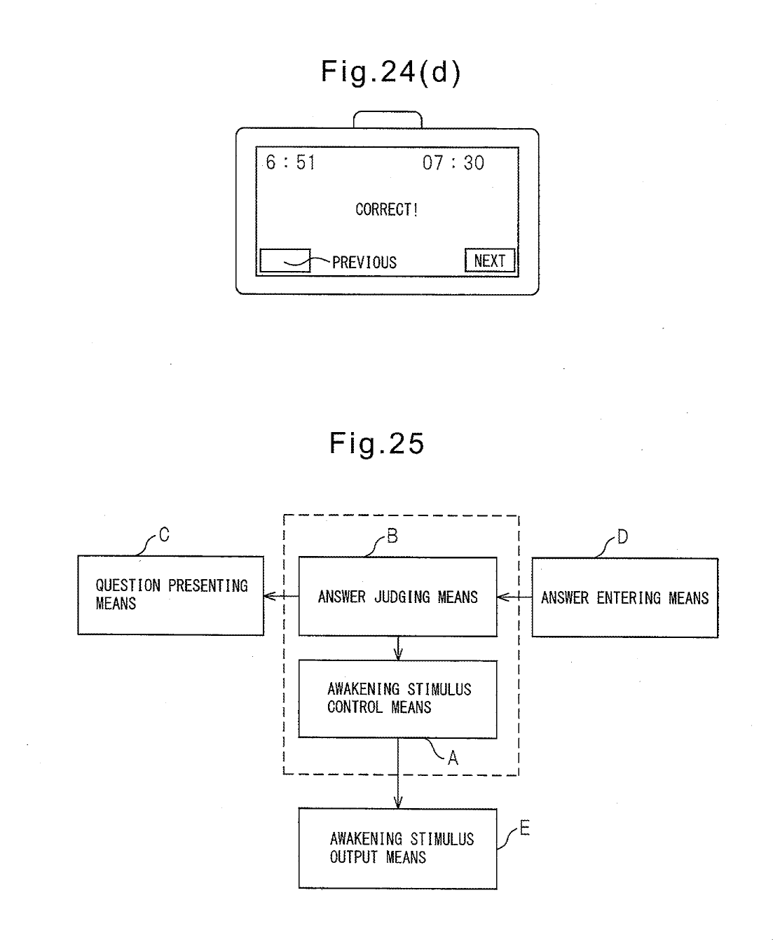

FIG. 22 is a sequence diagram illustrating the sequence of operations performed between the learning apparatus 200 and the center server 218 at the time of alarm activation. Specifically, FIG. 22 shows the case where the number of questions is increased or decreased according to the ranking order. FIG. 24 shows display examples (1) to (4) produced by the learning apparatus 200.

First, the learning apparatus 200 wakes up the user by producing a bell sound through the speaker 204 a predetermined time earlier than the alarm activation time (S210). As shown in FIG. 24(a), the current time is displayed on the touch panel display 213 of the learning apparatus 200, but by accounting for the time the user 230 takes to solve the questions, the current time is earlier than the alarm set time displayed in the alarm activation time display area 213a.

When the user 230 depresses the alarm button 203 on the learning apparatus 200 to lock it in position, the alarm stops, and thus the bell sound stops (S211). When the bell sound stops, the alarm button 203 on the learning apparatus 200 outputs the alarm stop signal Ah, which is supplied via the user interface unit 212 to the question presenting means 261 in the overall control unit 206.

Then, as shown in FIG. 24(b), the question presenting means 261 produces the first question on the touch panel display 213 of the learning apparatus 200 via the user interface unit 212 (S212).

After checking the first question, the user 230 presses the NEXT button 213n on the touch panel display 213 to request the display of a screen for entering an answer (S213).

In response, the learning apparatus 200 displays the answer entering screen on the touch panel display 213 (S214). That is, as shown in FIG. 24(c), the screen for entering the answer to the first question is displayed on the touch panel display 213.

Then, the user 230 enters the answer by pressing an answer button displayed on the touch panel display 213 (S215). More specifically, the user 230 presses one or the other of the answer buttons A and B on the touch panel display 213 shown in FIG. 24(c).

Next, the learning apparatus 200 displays a message on the touch panel display 213 to indicate whether the user's answer is correct or not (S216). More specifically, a message indicating whether the answer to the first question is correct or not is displayed on the touch panel display 213, as shown in FIG. 24(d).

Next, the user 230 presses the NEXT button 213n to request the display of the next screen (S217).

The learning apparatus 200 presents the result of the answer to the user 230 and, at the same time, requests the center server 218 to store the answer history, i.e., the user's performance results (S218). The center server 218 stores the answer history in the answer history DB 287 (S218a).

The process from S212 to S218a described above is the basic process relating to the question presentation, answer entering, and history storage, and may hereinafter be sometimes referred to as the “answer entering/storing routine R204.”

The answer entering/storing routine R204 is repeated as many times as the number of standard questions acquired in the process shown in FIG. 19. That is, in the process shown in FIG. 22, the standard questions are presented to all the users.

When the presentation of the questions and the entering of the answers to them are all completed, the learning apparatus 200 sends a ranking order request to the center server 218 (S219).

When the ranking order request is received, the center server 218 searches the answer history DB 287 to check the answer status of each user belonging to the same group from the answer history of the user, and determines how the requesting user 230 ranks within the group in terms of the time required to finish answering the standard questions (S219a). Alternatively, the ranking within the group may be determined in order of the time the first question was answered. Further, the center server 218 may use the previously obtained correct answer percentage ranking as the ranking information. The previous correct answer percentage ranking can be calculated from the results obtained by searching the answer history DB 287.

Next, the center server 218 returns the ranking information obtained in S219a to the learning apparatus 200 (S220).

Then, based on the ranking information, i.e., the order ranking and the correct answer percentage ranking, the learning apparatus 200 adjusts the quantity and quality of the questions to be presented (S221). More specifically, based on the ranking information, the adjusting means 262 contained in the question presenting means 261 in the overall control unit 206 of the learning apparatus 200 shown in FIG. 15 adjusts the quantity, quality, and organization of the questions to be presented.

For example, all the reserve questions are presented to the user who was ranked first, and the number of reverse questions to be presented is reduced by one as the ranking decreases. In this case, the presentation of the reserve questions is regarded as a bonus. Conversely, no reserve questions may be presented to the user who was ranked first, and the number of reverse questions to be presented may be increased by one as the ranking decreases. In this case, the presentation of the reserve questions is regarded as a penalty. Either method may be employed. If there are no additional questions, the process proceeds to S230.

When the number of additional questions is determined, the learning apparatus 200 presents a message to the user (S222). Though not shown here, a message such as “You are ranked first. You get five bonus questions.” may be presented here. The user 230 presses the NEXT button 213n to request the display of the next screen (S223).

The learning apparatus 200 repeats the answer entering/storing routine R204 as many times as the number of questions determined in S221. That is, the process of presenting a question, accepting an answer from the user 230, and requesting the center server 218 to store the history is repeated. When the process of question presentation, answer entering, and history storing is completed for all the questions, the process proceeds to S230.

When all the questions specified in the registered course have been presented and answered, the learning apparatus 200 displays an end message on the touch panel display 213 (S230). For example, a character string such as “There are no more questions” is displayed.

It is also possible to alert the user by constantly displaying the user's ranking information in the intra-group ranking display area 213g of the touch panel display 213 of the learning apparatus 200.

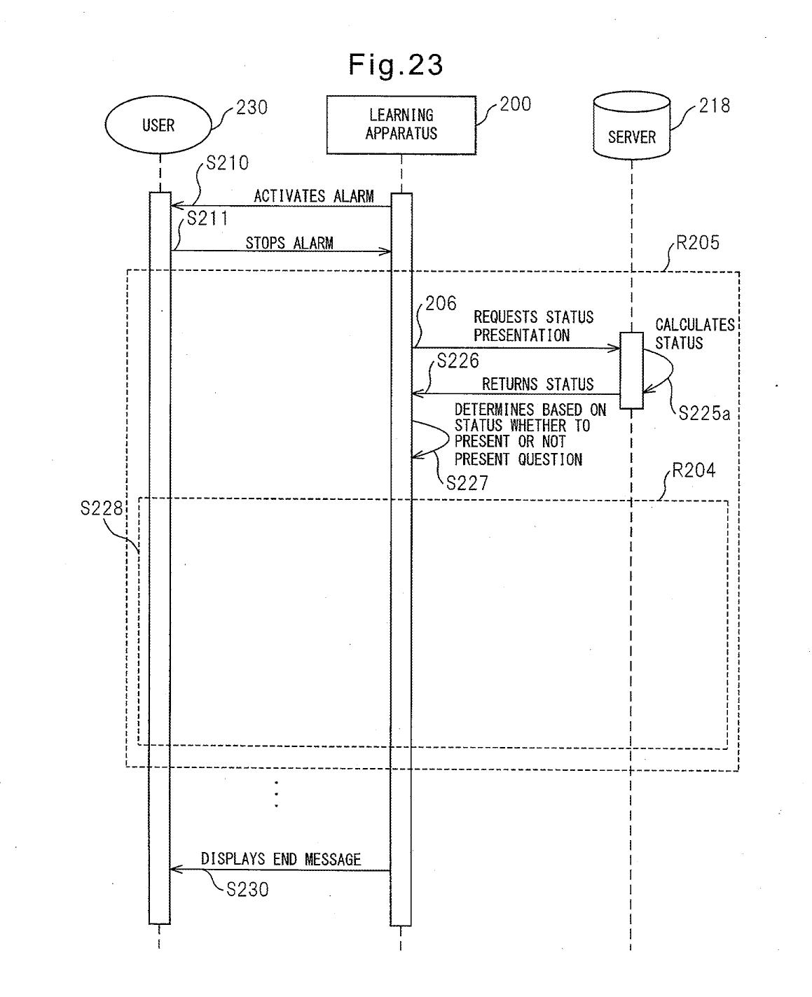

FIG. 23 is a sequence diagram illustrating another example of the sequence of operations performed between the learning apparatus 200 and the center server 218 at the time of alarm activation. Specifically, FIG. 23 shows the case where the number of questions is increased or decreased, depending on the question answered status of other users.

In FIG. 23, S210 (alarm sounding) and S211 (alarm stopping) are the same as S210 and S211 in FIG. 22, and the description thereof will not be repeated here. For all the questions acquired in the process shown in FIG. 19, the learning apparatus 200 executes a “selective answer entering/storing routine R205” by carrying out the steps S225 to S228 described hereinafter.

First, the learning apparatus 200 makes a status presentation request to the center server 218 (S225). The status presentation request carries the user ID of the user 230 and the presentation information ID of the question about which a decision as to whether or not to present the question is to be made.

When the status presentation request is received from the learning apparatus 200, the center server 218 searches the assigned group DB 286 using the user ID, and identifies the users belonging to the same group, as earlier described with reference to FIG. 17. Further, the center server 218 searches the answer history DB 287 using the presentation information ID, and checks whether the question has already been answered correctly by any one of the identified users.

The center server 218 returns the result of the checking to the learning apparatus 200 (S226).

Next, based on the question answered status returned from the center server 218, the learning apparatus 200 determines whether or not to present the question to the user 230 (S227). In the example shown in FIG. 23, if the question has not yet been answered by any of the other users, the process proceeds to S228 to present the question to the user 230. If the question has already been answered by any one of the other users, the process does not proceed to S228, and hence, the question is not presented to the user 230.

The process of S228 is the same as the process carried out in the previously described answer entering/storing routine R204; that is, the user 230 enters an answer to the question presented by the learning apparatus 200, and the answer history is recorded in the center server 218.

When there are no more questions to be presented, the learning apparatus 200 displays an end message to the user (S230). This process is the same as that of S230 earlier described with reference to FIG. 22.

In the example shown in FIG. 23, if the question to be presented has already been answered by any one of the other users belonging to the same group, the question is not presented to the user 230. It thus becomes possible to achieve, for example, a process in which the users belonging to the same group solve questions by dividing the workload among them.

In the learning apparatus 200 shown in FIGS. 15 to 24 and the learning system using the learning apparatus 200, because of the provision of the external interface unit 207 it becomes possible to provide learning materials and learning methods appropriate to the user by communicating with the center server 218 via the Internet 221 and checking the learning status of the other users. Since this achieves a learning process having a greater variety than when the user alone performs the learning, a further enhanced learning effect can be expected. For example, it becomes possible to provide a learning system in which the plurality of users forming the same group improve each other by working together cooperatively, thus aiming to improve their performance in a more effective manner. It also becomes possible to provide sufficient learning materials to the users via the network.

1. A learning apparatus comprising:
timer;
time setting unit for setting a presentation time of a question to a user;
question presenting unit for presenting the question in accordance with the setting made by the time setting unit; and
preview presenting unit for presenting to the user, before the presentation time of the question, a preview of contents which includes at least the same question to be presented by the question presenting unit.

2. (canceled)

3. The learning apparatus according to claim 1, wherein the preview presenting unit further presents a hint about an answer to the question to be presented by the question presenting unit.

4. The learning apparatus according to claim 1, wherein the preview presenting unit further presents a method of solving the question to be presented by the question presenting unit.

5. The learning apparatus according to claim 3, further comprising operating unit for accepting an answer from the user.

6. The learning apparatus according to claim 1, wherein the time setting unit is an alarm setting unit for setting an alarm, and wherein the learning apparatus further comprises alarm activating unit for activating the alarm in accordance with the setting made by the time setting unit, and alarm stopping unit for stopping the alarm, wherein the alarm setting unit adjusts a time at which the alarm activating unit activates the alarm, according to the quantity or quality of the questions to be presented by the question presenting unit.

7. The learning apparatus according to claim 6, wherein the alarm stopping unit has a snooze function, and increases or decreases the number of questions to be presented by the question presenting unit, according to the number of alarm activations that occurred due to activation of the snooze function.

8. The learning apparatus according to claim 6, further comprising presentation content adjusting unit for adjusting presentation content according to a time difference between an alarm setting time, at which the alarm activation time is set by the alarm setting unit, and the alarm activation time.

9. The learning apparatus according to claim 8, wherein the presentation content adjusting unit adjust the presentation content by reducing the quantity or quality of the questions when the time difference is small and by increasing the quantity or quality of the questions when the time difference is large.

10. The learning apparatus according to claim 8, wherein the alarm setting time corresponds to the time at which the user goes to bed, and the alarm activation time corresponds to the time at which the user gets up.

11. A learning apparatus comprising:
timer;
time setting unit for setting a presentation time of a question to a user;
question presenting unit for presenting the question in accordance with the setting made by the time setting unit; and
external connecting unit capable of establishing a connection to an electrical communication network,
wherein the external connecting unit acquires, from a center server connected to the electrical communication network, information that varies according to question answered status of other users within a group formed by a prescribed number of users each using a different learning apparatus connected to the electrical communication network.

12. The learning apparatus according to claim 11, wherein the question presenting unit changes the quantity or quality of the questions according to a ranking within the group.

13. The learning apparatus according to claim 11, wherein the question presenting unit does not present a question to the user if the question has already been answered correctly by some other user using one of the different learning apparatuses connected to the electrical communication network.

14. The learning apparatus according to claim 11, further comprising annunciating unit for annunciating ranking status within the group.

15. The learning apparatus according to claim 11, wherein the question presenting unit increases or decreases the number of questions according to the time at which to answer the questions.
